(19) United States
(12) Patent Application Publication
(10) Pub. No.: US 2023/0156038 A1
(43) Pub. Date: May 18, 2023

(54) SYSTEMS, METHODS, AND APPARATUS TO OPTIMIZE TELEMETRY COLLECTION AND PROCESSING OF TRANSPORT LAYER SECURITY PARAMETERS

(71) Applicant: McAfee, LLC, San Jose, CA (US)

(72) Inventors: Tirumaleswar Reddy Konda, Bangalore (IN); Shashank Jain, Bengaluru (IN); Piyush Pramod Joshi, Aurangabad (IN); Himanshu Srivastava, Bangalore (IN)

(21) Appl. No.: 17/526,825

(22) Filed: Nov. 15, 2021

(51) Int. Cl. H04L 29/06; H04L 9/06; H04L 9/32

(52) U.S. Cl. CPC H04L 63/166; H04L 9/0643; H04L 9/3239

(57) ABSTRACT

Methods, apparatus, systems and articles of manufacture are disclosed to optimize telemetry collection and processing of Transport Layer Security (TLS) parameters. An example apparatus includes at least one memory, instructions, and at least one processor to execute the instructions to generate a TLS client sub-profile based on first telemetry data associated with a client device, generate a TLS server sub-profile based on second telemetry data associated with a first server, generate a hash value based on at least one of the TLS client sub-profile or the TLS server sub-profile, compare the hash value to a plurality of hash values corresponding to known TLS profiles, and, in response to identifying the at least one of the TLS client sub-profile or the TLS server sub-profile as a unique TLS profile based on the comparisons, transmit the at least one of the first or second telemetry data to a second server.

### FIELD OF THE DISCLOSURE

This disclosure relates generally to network telemetry and, more particularly, to systems, methods, and apparatus to optimize telemetry collection and processing of Transport Layer Security parameters.

### BACKGROUND

Transport Layer Security (TLS) is a cryptographic communication protocol designed to provide communication security over a computer network. TLS may be used to encrypt communication between web applications and servers, such as web browsers loading a website. TLS may also be used to encrypt other communications such as email, voice over IP (VoIP), and Internet-of-Things (IoT) messages.

### BRIEF DESCRIPTION OF THE DRAWINGS

FIG. 1 is an illustration of an example network telemetry system including an example telemetry controller providing example telemetry data from example Internet-of-Things (IoT) devices to an example central facility server.

FIG. 2 is an example implementation of the telemetry controller of FIG. 1.

FIG. 3 is an example implementation of the central facility server of FIG. 1.

FIG. 4 is a table of example Transport Layer Security (TLS) connection data corresponding to example IoT devices.

FIG. 5 is an example implementation of a TLS client sub-profile.

FIG. 6 is an example implementation of a TLS server sub-profile.

FIG. 7 is a flowchart representative of example machine readable instructions that may be executed to implement the example telemetry controller of FIGS. 1 and/or 2 to transmit example telemetry data to the example central facility server of FIGS. 1 and/or 3.

FIG. 8 is a flowchart representative of example machine readable instructions that may be executed to implement the example telemetry controller of FIGS. 1 and/or 2 to identify unique TLS profile(s) based on hash values.

FIG. 9 is a flowchart representative of example machine readable instructions that may be executed to implement the example central facility server of FIGS. 1 and/or 3 to distribute example firewall rules and/or example machine-learning model(s) to the example telemetry controller of FIGS. 1 and/or 2.

FIG. 10 is a flowchart representative of example machine readable instructions that may be executed to implement the example central facility server of FIGS. 1 and/or 3 to identify TLS profile(s) based on communications from the example telemetry controller of FIGS. 1 and/or 2.

FIG. 11 is a flowchart representative of example machine readable instructions that may be executed to implement the example telemetry controller of FIGS. 1 and/or 2 and/or the example central facility server of FIGS. 1 and/or 3 to execute mitigation measures based on detected malicious behavior.

FIG. 12 is a block diagram of an example processing platform structured to execute the example machine readable instructions of FIGS. 7, 8, and/or 11 to implement the example telemetry controller of FIGS. 1 and/or 2.

FIG. 13 is a block diagram of an example processing platform structured to execute the example machine readable instructions of FIGS. 9, 10, and/or 11 to implement the example central facility server of FIGS. 1 and/or 3.

FIG. 14 is a block diagram of an example software distribution platform to distribute software to client devices.

### DETAILED DESCRIPTION

The figures are not to scale. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Networking environments, such as an environment including one or more devices (e.g., computing devices) connected to a network (e.g., a computer network), include increasing numbers and/or types of devices. For example, an enterprise networking environment (e.g., computer network(s) managed by an enterprise Information Technology (IT) system, administrator, etc.) may include enterprise-managed computer servers, desktop computers, laptop computers, tablet computers, gateways, access points, Internet-of-Things (IoT) devices, etc. In some examples, a private networking environment, such as a private network owned by an entity (e.g., an individual, a business, etc.) may include privately-managed computer servers, desktop computers, laptop computers, tablet computers, gateways, access points, IoT devices, etc.

As used herein, the terms “Internet-of-Things device” or “IoT device” refers to a device connected to a network capable of receiving, processing, and/or transmitting data. For example, the IoT device may be a consumer electronics device, a manufacturing device, or any other device including processing circuitry and a network interface (e.g., network interface circuitry). Examples of IoT devices may include smart and/or network or Internet-enabled televisions (TVs), outlets, light bulbs, appliances (e.g., refrigerators, coffee machines, washers, dryers, dish washing machines, ovens, microwaves, water heaters, freezers, etc.), tablets (e.g., tablet computers), thermostats, video cameras, baby monitors, etc.

In examples disclosed herein, devices (e.g., enterprise-managed devices, private-managed devices such as IoT devices, etc.) may be communicatively coupled to a network. For example, the network may be a Bluetooth network, a Bluetooth Low Energy (BLE) network, a wireless fidelity (Wi-Fi) Direct network, or any other peer-to-peer (P2P) network. In some disclosed examples, the network may be a wireless local area network (WLAN), a wireless personal area network (WPAN), a wireless wide area network (WWAN), a Wi-Fi network, etc. In some examples, the network may be a client/server network (e.g., a network including a server for data storage) in which data is distributed via an intermediary device (e.g., a modem, a router, etc.).

A BLE network utilizes BLE communication protocols, which are implemented as WPAN communication protocols that facilitate wireless communications between BLE-compatible devices (e.g., desktop computers, laptop computers, tablets, smartphones, personal digital assistants (PDAs), IoT devices, etc.). Wi-Fi Direct is an example wireless technology standard enabling devices to connect to one another without the use of the wireless access point and a corresponding Internet connection. A Wi-Fi Direct connection allows users to display media, control devices, share information, and/or sync data without joining a traditional home, office, or hotspot network.

Transport Layer Security (TLS) may be utilized to protect communications over such networks. TLS is a cryptographic communication protocol designed to provide communication security over a network (e.g., a wired or wireless network, a Wi-Fi network, a BLE network, etc.). TLS may be used to encrypt communication between software applications and servers, such as web browsers loading a website, an IoT device providing data, etc. TLS may be overlaid onto existing communication protocols, such as BLE, to secure messages based on such communication protocols.

Typically, to defend networks against emerging attacks (e.g., malware attacks), off-path network security services may be offered that are pervasive, behavior-based, and complement on-path network security solutions. For example, an off-path network security service may be implemented by a network device (e.g., an access point, a gateway, a modem, a router, etc.) in a network that collects network traffic and transmits the network traffic to a server external to the network. In some such examples, the network device implements a sensor that collects and exports network telemetry (e.g., network telemetry data) to the server. For example, the network telemetry may include Internet Protocol (IP) traffic flows (e.g., 5-tuples including a source IP address and port number, a destination IP address and port number, and the protocol in use), TLS metadata, Domain Name System (DNS) messages, etc. In some such examples, the server may perform security threat analysis on the received network traffic and provide an outcome of the security threat analysis to the network device. For example, the outcome may include a detection of a malware flow, a policy violation, and/or an identification of a compromised endpoint. In some disclosed examples, an on-path network security service may be implemented by the network device performing the security threat analysis on the collected network traffic.

Off-path network security services may be utilized in private networks because installing host agents to execute on-path network security services on some network devices, such as IoT devices, is not viable due to limited hardware and/or software resources on such network devices. Off-path network security services may be utilized because malware flows may be encrypted to thwart on-path network security services such as deep packet inspection (DPI). Off-path network security services may be utilized in enterprise networks because such networks do not assume that all network devices in such networks are managed by the IT team or Mobile Device Management (MDM) devices. For example, some enterprise networks allow IoT devices to be connected and may not be managed by the IT team and have limited hardware and/or software resources to implement MDM. Some enterprise networks may operate based on a “Bring Your Own Device” (BYOD) policy and similarly may not be managed by the IT team.

Some off-path network security services require substantial resources (e.g., compute, memory, storage, and/or software resources) to process exported telemetry data. For example, a network device may export all or substantially all encountered TLS flows, TLS messages, TLS communications, etc., to a server. In some instances, the number of TLS flows from IoT devices with broad communication patterns (e.g., Internet-enabled computer voice assistants, streaming devices, etc.) may be significantly higher compared to headless IoT devices (e.g., smart outlets, smart appliances, etc.).

Examples disclosed herein improve telemetry collection and processing of TLS parameters (e.g., TLS flow parameters). In some disclosed examples, TLS flows (e.g., TLS packet flows, TLS communication flows, etc.) may be collected and/or otherwise obtained by a network device. For example, the network device may extract TLS parameters from a first communication from an IoT device to a server. In some such examples, the TLS parameters may include a protocol version, offered encryption algorithms, offered extensions, etc. In some disclosed examples, the network device may extract TLS parameters from a second communication from the server to the IoT device. For example, the TLS parameters may include a selected cipher suite, selected extensions, server certificate parameters, which may include common name, issuer, subject alt name, etc., etc.

In some disclosed examples, the network device may generate a TLS profile based on TLS parameters associated with a communication, such as a TLS flow, a TLS message, etc. For example, a TLS profile may be implemented by a set of one or more observable TLS parameters that may be used to establish one or more TLS connections. In some such disclosed examples, the TLS profile may be implemented by one or more sub-profiles. For example, the network device may generate a TLS client sub-profile based on first TLS parameters associated with the first communication. In some such examples, the network device may generate a TLS server sub-profile based on second TLS parameters associated with the second communication. In some disclosed examples, the network device may determine a first hash value based on the TLS client sub-profile and a second hash value based on the TLS server sub-profile. In some disclosed examples, the network device may compare the first hash value and/or the second hash value to known hash values to determine whether the first hash value and/or the second hash value correspond to unique TLS profile(s). For example, the known hash values may correspond to known sets of TLS parameters associated with a malware flow or a legitimate flow (e.g., a non-malware flow). In some disclosed examples, in response to identifying unique TLS profile(s) based on the first hash value and/or the second hash value, the network device may export at least one of the unique TLS profile(s) or the associated TLS telemetry data (e.g., TLS network telemetry data) of the unique TLS profile(s) to an external server. In some disclosed examples, the external server may implement off-path network security services such as anomaly detection, and/or, more generally, malware detection, prevention, and/or mitigation, to reduce a risk of compromise of the network device and improve the security of the network device by identifying malware flows.

Advantageously, examples disclosed herein reduce a quantity of telemetry data to be exported to the external server from a full export of all telemetry data to telemetry data associated with the unique TLS profile(s) without adversely impacting the identification of malware flows. Advantageously, examples disclosed herein improve the efficiency at which a TLS flow may be identified as either malware (e.g., a malicious flow) or legitimate (e.g., a benign flow) because a reduced number of TLS flows may be profiled rather than all TLS flows, and the reduced number may achieve a significantly reduction in resources and time duration needed to classify such TLS flows.

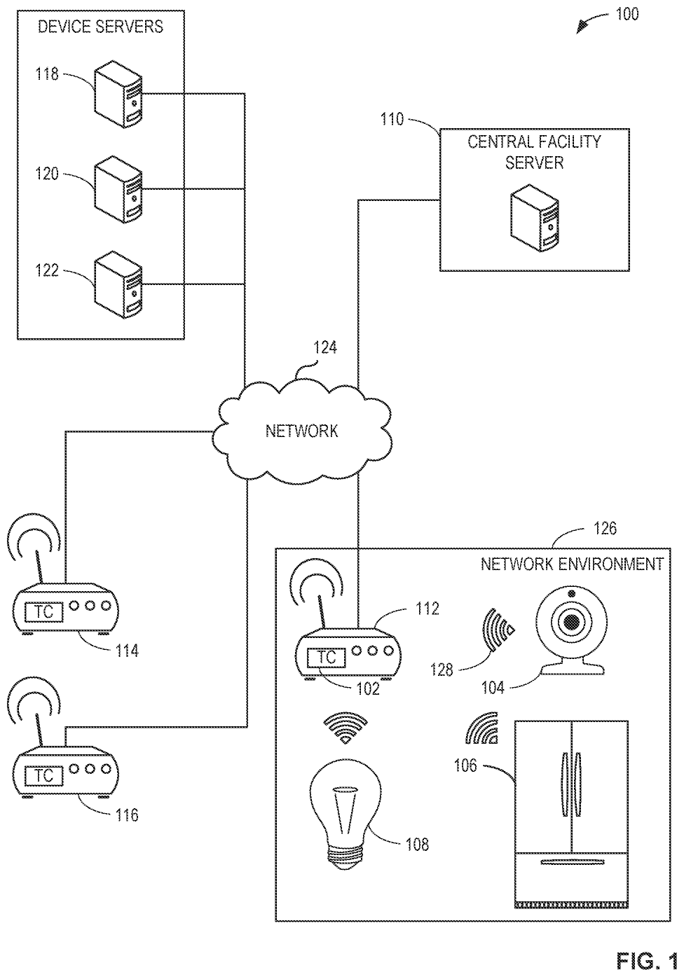

FIG. 1 is an illustration of an example network telemetry system 100 including an example telemetry controller (TC) 102 providing example telemetry data from example Internet-of-Things (IoT) devices 104, 106, 108 to an example central facility server 110. In this example, the network telemetry system 100 includes a first example network device 112, a second example network device 114, and a third example network device 116, a first example server 118, a second example server 120, a third example server 122, and an example network 124. In this example, the first network device 112, the second network device 114, and the third network device 116 may implement the telemetry controller 102.

In this example, the first network device 112 and the IoT devices 104, 106, 108 are part of an example network environment 126. In this example, the network environment 126 is a household. However, the network environment 126 may be any other location, such as, for example an airport, an Internet café, a factory, a library, an office (e.g., an office building), a restaurant, a retail store, etc. For example, the network environment 126 may implement an enterprise network environment, a private network environment, a consumer network environment, a personal network environment, etc. While in the illustrated example a single network environment 126 is shown, any number and/or type(s) of network environment may be used. In some examples, the second network device 114 and/or the third network device 116 may be part of other network environments. For example, the second network device 114 may be part of another household, the third network device 116 may be part of an office building, etc.

In the illustrated example of FIG. 1, the first network device 112, the second network device 114, and the third network device 116 are routers. For example, the first network device 112, the second network device 114, and the third network device 116 may be an interface circuit (e.g., interface circuitry, an interface logic circuit, etc.) that implements a communication device such as a transmitter, a receiver, a transceiver, a modem, a gateway (e.g., an enterprise gateway, a residential gateway, etc.), a wireless access point, and/or a network interface to facilitate exchange of data with external machines (e.g., computing devices of any kind) via the network 124. In some examples, the first network device 112, the second network device 114, and/or the third network device 116 may effectuate communication via, for example, a Bluetooth connection, an Ethernet connection, a digital subscriber line (DSL) connection, a telephone line connection, a coaxial cable system, a satellite system, a line-of-site wireless system, a cellular telephone system, etc. In some examples, the first network device 112, the second network device 114, and/or the third network device 116 may be a Secure Home Platform router and/or otherwise implement Secure Home Platform provided by McAfee, LLC.

The example network 124 of the illustrated example of FIG. 1 is the Internet. However, the network 124 may be implemented using any suitable wired and/or wireless network(s) including, for example, one or more one or more Local Area Networks (LANs), one or more WLANs, one or more cellular networks, one or more private networks, one or more public networks, etc. In some examples, the network 124 enables the central facility server 110 to be in communication with one(s) of the network devices 112, 114, 116. In some examples, the network 124 enables one(s) of the servers 118, 120, 122 to be in communication with one(s) of the IoT devices 104, 106, 108.

In the illustrated example of FIG. 1, the IoT devices 104, 106, 108 include a first example IoT device 104, a second example IoT device 106, and a third example IoT device 108. In this example, the first IoT device 104 is a camera. For example, the first IoT device 104 may be a camera (e.g., an indoor or outdoor camera, a security camera, a webcam, an IP camera, etc.) that can capture still images and/or live video. In some such examples, the first IoT device 104 is an IP camera or netcam that may receive control data (e.g., commands, configurations, settings, etc.) and send image data via an IP network. Alternatively, the first IoT device 104 may be any other type of image capture device.

In the illustrated example of FIG. 1, the second IoT device 106 is a smart appliance, such as a refrigerator. For example, the second IoT device 106 may be an Internet-enabled refrigerator that may receive control data and send data via an IP network. In this example, the third IoT device 108 is a smart light bulb. For example, the third IoT device 108 may be an Internet-enabled light bulb that may receive control data and send data via an IP network. Alternatively, the network environment 126 may include fewer or more IoT devices than depicted in FIG. 1. Additionally or alternatively, the network environment 126 may include any other number and/or type of IoT device, such as smart and/or network or Internet-enabled televisions (TVs), outlets, coffee machines, washers, dryers, dish washing machines, ovens, microwaves, water heaters, freezers, tablets, thermostats, baby monitors, etc. Additionally or alternatively, the network environment 126 may include a server, a personal computer, a workstation, a mobile device (e.g., a cell phone, a smart phone, a tablet,), a personal digital assistant (PDA), an Internet appliance, a digital versatile disk (DVD) player, a compact disk (CD) player, a digital video recorder (DVR), a Blu-ray player, a gaming console, a personal video recorder, a set top box, a headset or other wearable device, a hub device (e.g., a smart home automation hub), a bridge device, (e.g., a smart home automation bridge device), or any other type of computing device. For example, one(s) of the network devices 112, 114, 116 may be a hub device, a bridge device, etc., that connects to one or more networks (e.g., a Wi-Fi network, a WLAN, a LAN, etc.) of the network environment 126. In some such examples, the first network device 112 implemented with a hub device, a bridge device, etc., may be in communication with one(s) of the IoT devices 104, 106, 108 via the one or more networks and/or via one or more example wireless connections 128.

The IoT devices 104, 106, 108 of the illustrated example may be communicatively coupled to the first network device 112 via the wireless connections 128. For example, the wireless connections 128 may implement a Bluetooth network, a BLE network, a Wi-Fi Direct network, or any other P2P network. In some examples, the wireless connections 128 may implement a WLAN, a WPAN, a WWAN, a Wi-Fi network, etc. In some examples, the wireless connections 128 may implement TLS flows (e.g., TLS communication flows, TLS data flows, TLS messages, etc.) between one(s) of the IoT devices 104, 106, 108 and one(s) of the servers 118, 120, 122. For example, the first IoT device 104, the second IoT device 106, and/or the third IoT device 108 may implement client devices (e.g., TLS client devices, IoT client devices, etc.).

In the illustrated example of FIG. 1, the IoT devices 104, 106, 108 may transmit data to and/or receive data from one(s) of the servers 118, 120, 122. In some examples, the first server 118, the second server 120, and/or the third server 122 may implement device servers that exchange data with device(s), such as one(s) of the IoT devices 104, 106, 108. For example, the first server 118 may be managed by a first entity that is associated with the first IoT device 104. In some such examples, the first entity may be a manufacturer, a vendor, etc., of the first IoT device 104. In some examples, the second server 120 may be managed by a second entity that is associated with the second IoT device 106. In some such examples, the second entity may be a manufacturer, a vendor, etc., of the second IoT device 106. In some examples, the third server 122 may be managed by a third entity that is associated with the third IoT device 108. In some such examples, the third entity may be a manufacturer, a vendor, etc., of the third IoT device 108. In some examples, the first server 118, the second server 120, and/or the third server 122 may be managed by the first entity that is associated with the first IoT device 104. For example, the first entity may manage a plurality of servers hosted in different geographic locations. In some such examples, an IoT device, such as the first IoT device 104, may have TLS flows with multiple ones of the first server 118, the second server 120, and/or the third server 122.

In some examples, one(s) of the IoT devices 104, 106, 108 communicate with one(s) of the servers 118, 120, 122 by utilizing TLS. TLS is an encryption protocol to secure communications between devices. A TLS handshake technique is utilized to initiate a TLS communication session between a server (e.g., one of the servers 118, 120, 122) and a client (e.g., one of the IoT devices 104, 106, 108). During the TLS handshake, the client and the server exchange messages to acknowledge each other, very each other, establish the encryption algorithms they will use, and agree on session keys. The TLS handshake may be implemented with a “client hello” message and a “server hello” message. For example, the first IoT device 104 may initiate the handshake with the first server 118 by sending a “hello” message to the first server 118. In some examples, the client hello message may include one or more TLS parameters, such as a TLS version that the first IoT device 104 supports, the cipher suites (e.g., a set of encryption algorithms for use in establishing a secure communications connection) that the first IoT device 104 supports, a string of random bytes known as the “client random”, etc. In some such examples, in response to receiving the client hello message from the first IoT device 104, the first server 118 may transmit a “hello” message to the first IoT device 104. In some examples, the server hello message may include one or more TLS parameters, such as the selected TLS version, the cipher suite selected by the first server 118, a string of random bytes known as the “server random”, etc. The TLS handshake may further be implemented by the first server 118 providing the first IoT device 104 with a Secure Sockets Layer (SSL) certificate of the first server 118 and an encryption exchange. For example, the TLS handshake may implement the encryption exchange with a Rivest-Shamir-Adleman (RSA) key exchange algorithm, an ephemeral Diffie-Hellman (DH) handshake, etc.

In some examples, the telemetry controller 102 of the first network device 112 obtains TLS flows from one(s) of the IoT devices 104, 106, 108. In some examples, the telemetry controller 102 exports TLS parameters included in the TLS flows to the central facility server 110. For example, the central facility server 110 may implement off-path security service(s) to detect malware flows, policy violations, and/or compromised endpoints (e.g., whether one(s) of the IoT devices 104, 106, 108 is/are compromised) based on the TLS parameters obtained from the telemetry controller 102. In some examples, if the telemetry controller 102 exports all (e.g., substantially all) of the TLS parameters for all (e.g., substantially all) of the TLS flows, the telemetry controller 102 may cause increased resource utilization (e.g., compute (e.g., processor or central processing unit (CPU)) resources, memory resources, network interface resources, etc.) of the first network device 112 to facilitate the export of the TLS parameters. In some examples, the telemetry controller 102 may cause the central facility server 110 to increase resource capacity (e.g., compute, memory, network interface, etc., capacity) to process the TLS parameters and/or implement the off-path security service(s) based on the TLS parameters.

Advantageously, the telemetry controller 102 may reduce the resource utilization of the first network device 112 and/or one(s) of the second network device 114 and/or the third network device 116 by identifying unique TLS flows. Advantageously, the telemetry controller 102 may cause a reduction in the resource capacity of the central facility server 110 by causing the central facility server 110 to process the identified unique TLS flows rather than an entirety or a substantial portion of the TLS flows executed in the network environment 126.

In some examples, the telemetry controller 102 may extract one or more TLS parameters from a TLS flow. For example, the telemetry controller 102 may obtain a first TLS flow (e.g., a client hello message) transmitted from the first IoT device 104 to the first server 118 and extract one or more TLS parameters from the first TLS flow. In some examples, the telemetry controller 102 may obtain a second TLS flow (e.g., a server hello message) transmitted from the first server 118 to the first IoT device 104 in response to the first server 118 receiving the first TLS flow, and extract one or more TLS parameters from the second TLS flow.

In some examples, the telemetry controller 102 may generate a first TLS profile (e.g., a client sub-profile, a TLS client sub-profile, etc.) based on the one or more TLS parameters from the first TLS flow. In some examples, the telemetry controller 102 may generate a second TLS profile (e.g., a server sub-profile, a TLS server sub-profile, etc.) based on the one or more TLS parameters from the second TLS flow. In some such examples, an IoT device, such as the first IoT device 104, may have a single TLS client sub-profile that is associated with multiple TLS server sub-profiles. For example, the first server 118, the second server 120, and/or the third server 122 may be managed by the same entity that is associated with the first IoT device 104. In some such examples, the first IoT device 104 may communicate with multiple servers managed by the same entity.

In some examples, the telemetry controller 102 may generate a first hash value based on the first TLS profile and a second hash value based on the second TLS flow. For example, the telemetry controller 102 may execute a hash algorithm (e.g., a Secure Hash Algorithm (SHA), an SHA-1 algorithm, an SHA-2 algorithm (e.g., SHA-256, SHA-384, SHA-512, etc., algorithms), etc.) on the one or more TLS parameters of the first TLS flow to generate the first hash value and the one or more TLS parameters of the second TLS flow to generate the second hash value. In some examples, the first hash value may implement a first fingerprint (e.g., a TLS fingerprint, a TLS profile fingerprint, etc.) and the second hash value may implement a second fingerprint.

In some examples, the telemetry controller 102 may compare at least one of the first fingerprint or the second fingerprint to a known fingerprint. For example, the telemetry controller 102 may compare the first fingerprint to one or more fingerprints stored by the telemetry controller 102, and/or, more generally, the first network device 112. In some such examples, the one or more stored fingerprints may correspond to previously generated fingerprints associated with previous TLS flows encountered by the first network device 112, the second network device 114, and/or the third network device 116. For example, the third network device 116 may generate a fingerprint based on a TLS flow obtained by the third network device 116. In some such examples, the third network device 116 may transmit the fingerprint to the central facility server 110 via the network 124. In some such examples, the central facility server 110 may identify the fingerprint as a unique fingerprint, such as a fingerprint based on a set of one or more TLS parameters not previously analyzed by the central facility server 110. In some such examples, in response to identifying the fingerprint as a unique fingerprint, the central facility server 110 may propagate and/or otherwise distribute the fingerprint to the first network device 112, the second network device 114, etc.

In some examples, in response to the first network device 112 determining that the first fingerprint and/or the second fingerprint is/are unique fingerprints based on the first fingerprint and/or the second fingerprint not matching a known or stored fingerprint, the telemetry controller 102 of the first network device 112 may transmit the one or more TLS parameters associated with the first fingerprint and/or the second fingerprint as network telemetry to the central facility server 110. In some such examples, the first network device 112 may transmit time stamp data, a count of observation of each matched hash value, etc., to the central facility server 110 to improve statistical analysis of TLS communication behavior in network environments, such as the network environment 126. In some examples, in response to the first network device 112 determining that the first fingerprint and/or the second fingerprint is/are not unique fingerprints based on the first fingerprint and/or the second fingerprint matching a known or stored fingerprint, the telemetry controller 102 of the first network device 112 may not transmit the one or more TLS parameters associated with the first fingerprint and/or the second fingerprint as network telemetry to the central facility server 110. Advantageously, the telemetry controller 102 may decrease the quantity of network telemetry to be transmitted to the central facility server 110 by identifying network telemetry associated with unique TLS profiles.

The example central facility server 110 of FIG. 1 may implement one or more servers (e.g., computer servers) that obtain network telemetry from the telemetry controller 102 of one(s) of the network devices 112, 114, 116 via the network 124. In some examples, the central facility server 110 implements off-path security services to identify malware attacks, intrusions, threats, etc., associated with a network environment, such as the network environment 126, and/or determine whether a device, such as one(s) of the IoT devices 104, 106, 108, is exhibiting abnormal and/or malicious behavior and/or otherwise has been compromised by a malicious entity.

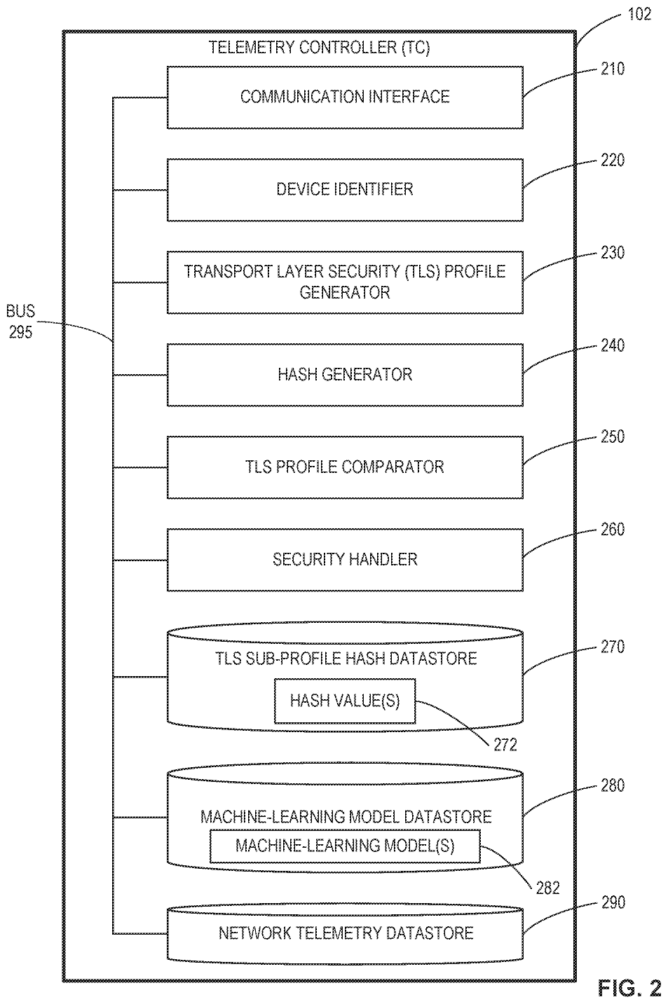

FIG. 2 is an example implementation of the telemetry controller 102 of FIG. 1. The telemetry controller 102 of FIG. 2 includes an example communication interface 210, an example device identifier 220, an example Transport Layer Security (TLS) profile generator 230, an example hash generator 240, an example TLS profile comparator 250, an example security handler 260, an example TLS sub-profile hash datastore 270, an example machine-learning model datastore 280, an example network telemetry datastore 290, and an example bus 295. In this example, the TLS sub-profile hash datastore 270 stores example hash value(s) 272. In this example, the machine-learning model datastore 280 stores example machine-learning model(s) 282.

In the illustrated example of FIG. 2, the communication interface 210, the device identifier 220, the TLS profile generator 230, the hash generator 240, the TLS profile comparator 250, the security handler 260, the TLS sub-profile hash datastore 270, the machine-learning model datastore 280, and the network telemetry datastore 290 are in communication with one(s) of each other via the bus 295. For example, the bus 295 may implement at least one of an Inter-Integrated Circuit (I2C) bus, a Serial Peripheral Interface (SPI) bus, or a Peripheral Component Interconnect (PCI) bus. Additionally or alternatively, the bus 295 may implement any other type of computing or electrical bus.

In the illustrated example of FIG. 2, the telemetry controller 102 includes the communication interface 210 to obtain information from and/or transmit information to the network 124 of FIG. 1. In some examples, the communication interface 210 transmits network telemetry data (e.g., TLS network telemetry data) to the central facility server 110 of FIG. 1. In some examples, the communication interface 210 receives and/or otherwise obtains TLS sub-profile hash data (e.g., hash values corresponding to TLS client sub-profiles, TLS server sub-profiles, etc.) from the central facility server 110. For example, the communication interface 210 may store the TLS sub-profile hash data as the hash value(s) 272. In some examples, the communication interface 210 implements a web server that receives the information from the network 124 and/or transmits the information to the network 124. In some examples, the communication interface 210 formats the information as HTTP message(s). However, the communication interface 210 may utilize any other message format and/or protocol such as, for example, a file transfer protocol (FTP), a simple message transfer protocol (SMTP), an HTTP secure (HTTPS) protocol, etc.

In some examples, the communication interface 210 obtains first TLS telemetry data associated with IoT device(s), such as one(s) of the IoT devices 104, 106, 108 of FIG. 1. For example, the communication interface 210 may obtain a client hello message transmitted by the first IoT device 104 to the first server 118. In some such examples, the communication interface 210 may extract and/or otherwise identify one or more TLS parameters included in the client hello message that correspond to the first IoT device 104. In some examples, the communication interface 210 obtains second TLS telemetry data associated with the IoT device(s), such as the one(s) of the IoT devices 104, 106, 108. For example, the communication interface 210 may obtain a server hello message transmitted by the first server 118 to the first IoT device 104. In some such examples, the communication interface 210 may extract and/or otherwise identify one or more TLS parameters included in the server hello message that correspond to the first server 118.

In some examples, the communication interface 210 may store the client hello message(s), the server hello message(s), TLS parameter(s), etc., in the network telemetry datastore 290. In some examples, the communication interface 210 transmits at least one of the first TLS telemetry data or the second TLS telemetry data to the central facility server 110. In some examples, the communication interface 210 transmits unique sub-profile(s) (e.g., a unique TLS client sub-profile, a unique TLS server sub-profile, etc.) to the central facility server 110.

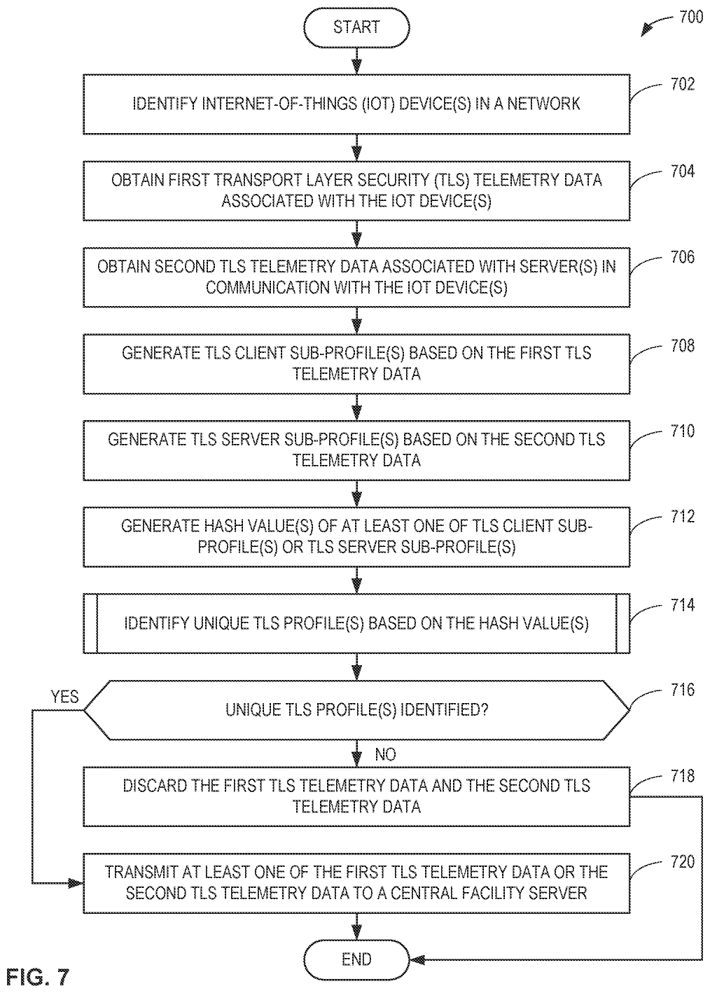

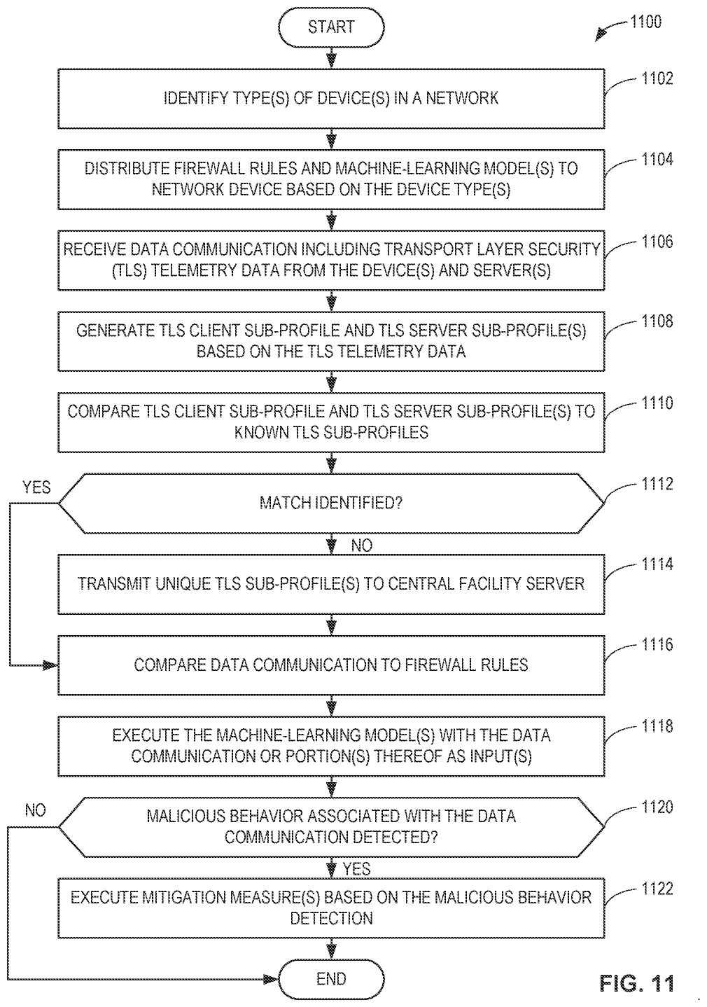

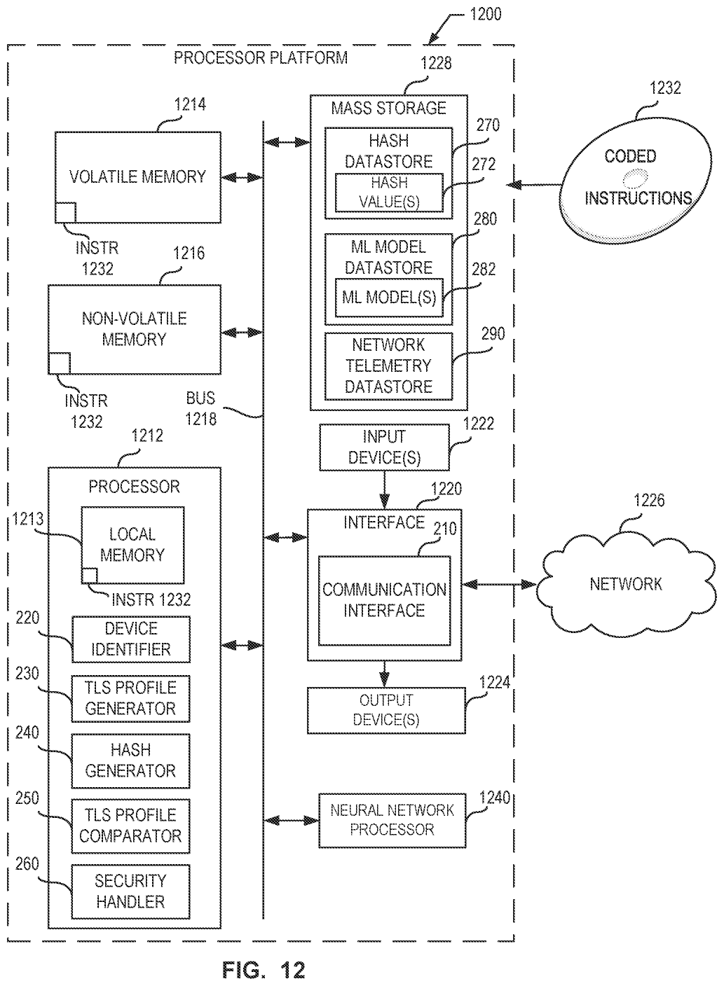

In some examples, the communication interface 210 implements example means for receiving and/or example means for transmitting. For example, the means for receiving and/or the means for transmitting may be implemented by executable instructions such as that implemented by at least blocks 704, 706, 720 of FIG. 7 and/or blocks 1102, 1106, 1114 of FIG. 11. In some examples, the executable instructions of blocks 704, 706, 720 of FIG. 7 and/or blocks 1102, 1106, 1114 of FIG. 11 may be executed on at least one processor such as the example processor 1212 of FIG. 12. In other examples, the means for transmitting is implemented by hardware logic, hardware implemented state machines, logic circuitry, and/or any other combination of hardware, software, and/or firmware. For example, the means for transmitting may be implemented by at least one hardware circuit (e.g., discrete and/or integrated analog and/or digital circuitry, a network interface card, a gateway, a router, an access point, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples in which a client device is a first client device with a first type, a TLS client sub-profile is a first TLS client sub-profile, and a TLS server sub-profile is a first TLS server sub-profile, the means for receiving is to receive at least one of a second TLS client sub-profile or a second TLS server sub-profile from a second server, and the second TLS client sub-profile and the second TLS server sub-profile corresponding to the second type.

In some examples, the means for transmitting is to transmit at least one of first telemetry data or second telemetry data to a second server (e.g., the central facility server 110) in response to identifying the at least one of a TLS client sub-profile or a TLS server sub-profile as a unique TLS profile based on comparisons of a hash value (e.g., a hash value based on the TLS client sub-profile and/or the TLS server sub-profile) to a plurality of known hash values corresponding to known TLS profiles. In some such examples, the first telemetry data is generated in response to a client device (e.g., one of the first IoT devices 104, 106, 108) transmitting a first data communication (e.g., a first TLS message, a first TLS flow, etc.) to a first server (e.g., one of the servers 118, 120, 122 of FIG. 1), and the second telemetry data is generated in response to the first server transmitting a second data communication (e.g., a second TLS message, a second TLS flow, etc.) to the client device.

In some examples in which the hash value is a first hash value based on the TLS client sub-profile, the means for transmitting is to, in response to the first hash value not matching a second hash value of the plurality of the hash values, transmit the first telemetry data and the second telemetry data to the second server, and the TLS client sub-profile identified as the unique TLS profile based on the first hash value not matching the second hash value.

In some examples in which the hash value is a first value based on the TLS client sub-profile, the means for transmitting is to, in response to a third hash value not matching a fourth hash value of the plurality of the hash values, transmit the first hash value and the second telemetry data to the second server, the fourth hash value corresponding to a known TLS server sub-profile, and the TLS server sub-profile identified as the unique TLS profile based on the third hash value not matching the fourth hash value.

In some examples in which the hash value is a first value, the means for transmitting is to, in response to a second hash value not matching a third hash value of the plurality of the hash values, transmit third telemetry data to the second server, the second hash value is based on a TLS server sub-profile, and the third hash value corresponds to a known TLS server sub-profile.

In the illustrated example of FIG. 2, the telemetry controller 102 includes the device identifier 220 to identify a device, such as an IoT device, in a network. In some examples, the device identifier 220 executes a discovery service and/or otherwise scans a network, such as a network associated with the network environment 126 of FIG. 1, to identify devices on the network. For example, the device identifier 220 may broadcast a signal (e.g., a Bluetooth signal, a Wi-Fi signal, etc.) that, when received by the IoT devices 104, 106, 108, the IoT devices 104, 106, 108 transmit identification data to the device identifier 220. In some such examples, the IoT devices 104, 106, 108 may transmit identification data including a vendor identifier (e.g., an identifier that indicates a manufacturer, vendor, or distributor of a respective one of the IoT devices 104, 106, 108), an IP address, a media access control (MAC) address, a serial number, a certificate, etc., of a transmitting one of the IoT devices 104, 106, 108. In some examples, the device identifier 220 may identify respective one(s) of the IoT devices 104, 106, 108 based on the identification data. In some examples, the device identifier 220 may store the identification data in the network telemetry datastore 290.

In some examples, the device identifier 220 implements example means for identifying. For example, the means for identifying may be implemented by executable instructions such as that implemented by at least block 702 of FIG. 7 and/or block 1102 of FIG. 11. In some examples, the executable instructions of block 702 of FIG. 7 and/or block 1102 of FIG. 11 may be executed on at least one processor such as the example processor 1212 of FIG. 12. In other examples, the means for identifying is implemented by hardware logic, hardware implemented state machines, logic circuitry, and/or any other combination of hardware, software, and/or firmware. For example, the means for identifying may be implemented by at least one hardware circuit (e.g., discrete and/or integrated analog and/or digital circuitry, a network interface card, a gateway, a router, an access point, an FPGA, a PLD, a FPLD, an ASIC, a comparator, an operational-amplifier (op-amp), a logic circuit, etc.) structured to perform the corresponding operation without executing software or firmware, but other structures are likewise appropriate. In some examples, the means for identifying may identify a type of a client device in a network.

In the illustrated example of FIG. 2, the telemetry controller 102 includes the TLS profile generator 230 to generate a profile (e.g., a TLS profile, a sub-profile, a TLS sub-profile, etc.) based on TLS telemetry data. For example, the TLS profile generator 230 may generate a TLS profile based on one or more TLS parameters included in a TLS communication from a first device to a second device. In some such examples, the TLS profile generator 230 may generate the TLS profile to include a profile name, one or more TLS versions that a device supports, one or more symmetric encryption algorithms supported that the device supports, one or more supported extension types that the device supports, one or more trust anchor certificates used by the device, one or more Subject Public Key Info (SPKI) keys or pins used by the device, one or more cryptographic hash algorithms that the device supports to generate the one or more SPKI keys, one or more pre-shared key exchange modes supported by the device, one or more named groups (e.g., Diffie-Hellman Exchange (DHE), Elliptic-curve Diffie-Hellman (ECDHE), etc.) that the device supports, one or more signature algorithms the client may utilize to validate a server certificate (e.g., when the device is a TLS client), one or more client key change algorithms and the client public key lengths (e.g., when the device is a TLS client), etc., and/or a combination thereof. In some examples, the TLS profile generator 230 generates the TLS profile by generating a tree structure based on the one or more TLS parameters, calculating a hash value based on values (e.g., Boolean values, integer values, string values, etc.) of the one or more TLS parameters, etc.

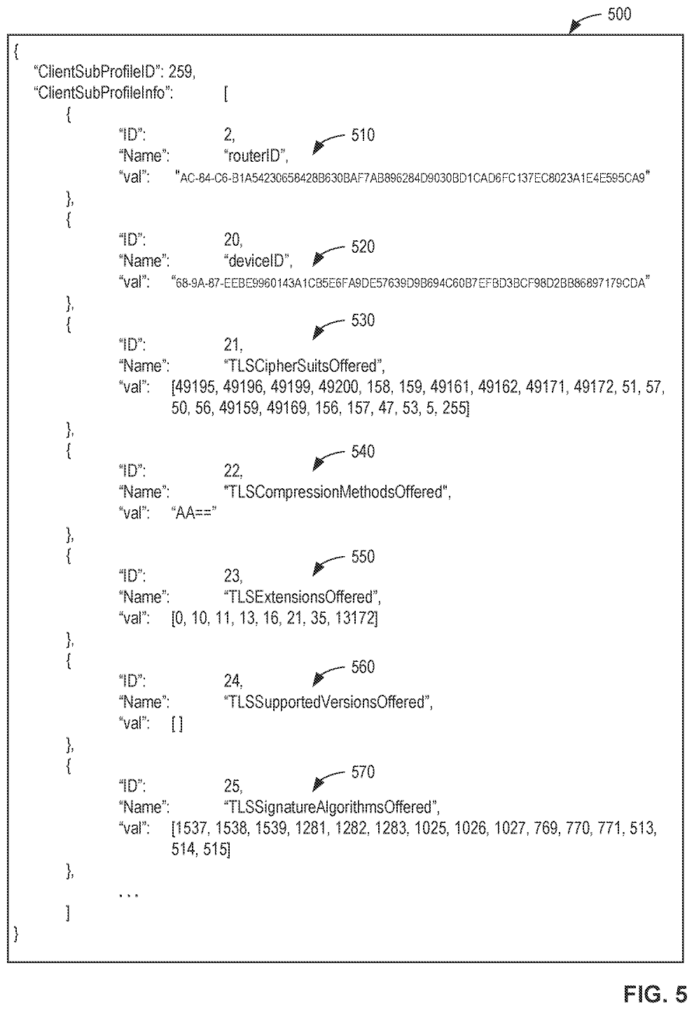

In some examples, the TLS profile generator 230 selects a device (e.g., one of the IoT devices 104, 106, 108) to process. In some such examples, the TLS profile generator 230 may select the first IoT device 104 to process. For example, the TLS profile generator 230 may generate a TLS client sub-profile based on first TLS telemetry data. In some such examples, the TLS profile generator 230 may identify the first TLS telemetry data included in a client hello message transmitted by the first IoT device 104 to the first server 118. An example implementation of a TLS client sub-profile is depicted in the illustrated example of FIG. 5.

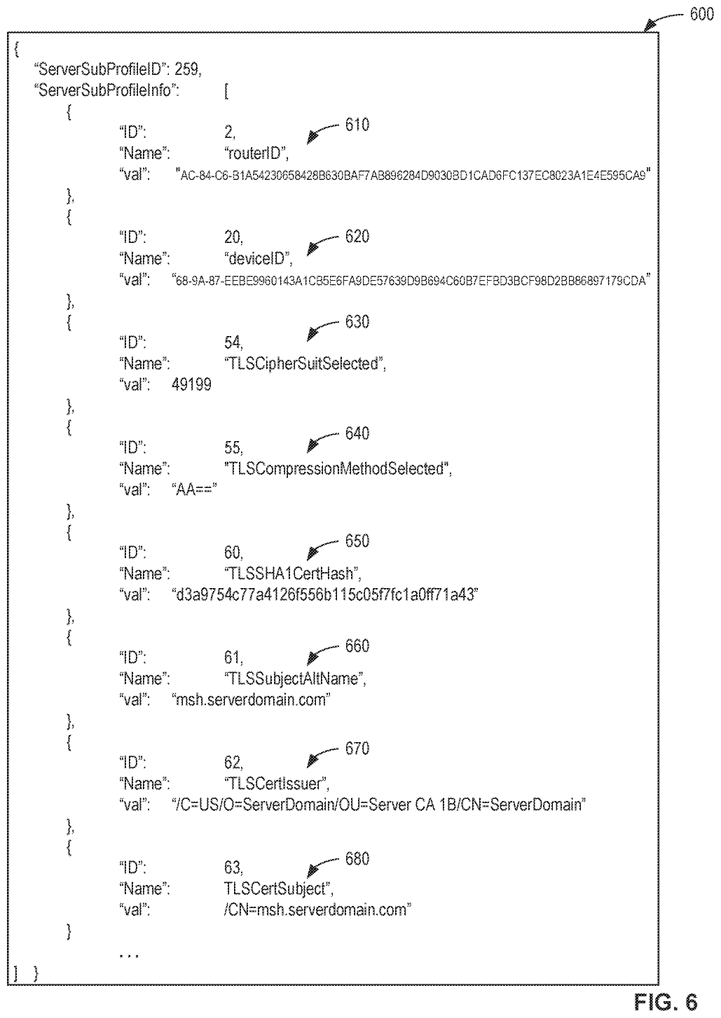

In some examples, the TLS profile generator 230 may generate a TLS server sub-profile based on second TLS telemetry data. For example, the TLS profile generator 230 may identify the second TLS telemetry data included in a server hello message transmitted by the server 118 in response to receiving the client hello message from the first IoT device 104. An example implementation of a TLS server sub-profile is depicted in the illustrated example of FIG. 6. In some examples, the TLS profile generator 230 selects another device, such as the second IoT device 106, to process the generation of TLS sub-profiles in response to processing and/or otherwise generating the TLS sub-profiles corresponding to the first IoT device 104.

In some examples, the TLS profile generator 230 implements example means for generating (e.g., first means for generating). For example, the first means for generating may be implemented by executable instructions such as that implemented by at least blocks 708, 710 of FIG. 7 and/or block 1108 of FIG. 11. In some examples, the executable instructions of blocks 708, 710 of FIG. 7 and/or block 1108 of FIG. 11 may be executed on at least one processor such as the example processor 1212 of FIG. 12. In other examples, the first means for generating is implemented by hardware logic, hardware implemented state machines, logic circuitry, and/or any other combination of hardware, software, and/or firmware. For example, the first means for generating may be implemented by at least one hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, the first means for generating is to generate a Transport Layer Security (TLS) client sub-profile based on first telemetry data associated with a client device, and the TLS client sub-profile includes a first TLS parameter associated with the client device. In some examples, the first means for generating is to generate a TLS server sub-profile based on second telemetry data associated with a first server, and the TLS server sub-profile includes a second TLS parameter associated with the first server.

In some examples in which the TLS server sub-profile is a first TLS server sub-profile, the first means for generating is to generate a second TLS server sub-profile based on third telemetry data associated with a third server, the second TLS server sub-profile includes the second TLS parameter or a third TLS parameter associated with the third server, and the third telemetry data is generated in response to the third server transmitting a data communication to the client device.

In the illustrated example of FIG. 2, the telemetry controller 102 includes the hash generator 240 to generate the hash value(s) 272 of at least one of a TLS client sub-profile or TLS server sub-profile(s). Advantageously, the telemetry controller 102 may utilize the hash generator 240 to generate hash values locally to the telemetry controller 102 to mitigate effects of a compromised IoT device. For example, if the first IoT device 104 becomes compromised by a malicious entity, the first IoT device 104 may be controlled to use a TLS-based attack (e.g., a TLS re-negotiation attack) on the first network device 112. Advantageously, by computing the hash locally to the telemetry controller 102, the telemetry controller 102 may eliminate and/or otherwise reduce a flood of TLS session telemetry communications to the central facility server 110.

In some examples, the hash generator 240 stores the hash value(s) 272 in the TLS sub-profile hash datastore 270. For example, the hash generator 240 may generate a hash value of a TLS profile by executing a hash algorithm (e.g., an SHA algorithm, an SHA-1 algorithm, an SHA-2 algorithm (e.g., SHA-256, SHA-384, SHA-512, etc., algorithms), etc.) on one or more TLS parameters of the TLS profile. In some examples, the hash generator 240 may generate, calculate, and/or otherwise determine a first hash value by executing a hash algorithm on one or more TLS parameters of a TLS client sub-profile. In some examples, the hash generator 240 may generate, calculate, and/or otherwise determine a second hash value by executing a hash algorithm on one or more TLS parameters of a first TLS server sub-profile associated with the TLS client sub-profile. In some examples, the hash generator 240 may generate, calculate, and/or otherwise determine a third hash value by executing a hash algorithm on one or more TLS parameters of a second TLS server sub-profile associated with the TLS client sub-profile and/or the first TLS server sub-profile.

Advantageously, the hash generator 240, and/or, more generally, the telemetry controller 102, may generate the hash value(s) 272 of TLS profile(s) to identify unique TLS profile(s) because the IoT devices 104, 106, 108 of FIG. 1 may exhibit a fixed number of TLS profiles even when more capabilities (e.g., applications, functions, routines, etc.) are implemented by the IoT devices 104, 106, 108. For example, the first IoT device 104 may exhibit 1 TLS client sub-profile when operating with a first set of capabilities (e.g., a minimal set of capabilities) and may exhibit 3 TLS client sub-profiles when operating with a second set of capabilities (e.g., a maximum set of capabilities) greater than the first set of capabilities. In some such examples, the hash generator 240 may generate a maximum number of 3 TLS client sub-profiles that encompasses the range and depth of capabilities exhibited and/or otherwise executed by the first IoT device 104.

Advantageously, the hash generator 240, and/or, more generally, the telemetry controller 102, may generate the hash value(s) 272 of TLS profile(s) to identify unique TLS profile(s) because TLS parameters in a client hello message exchanged by an IoT device as a client may be agnostic to a communication session while the TLS parameters negotiated by a server may be the only TLS parameters that are specific for that communication session. In some such examples, the hash generator 240 may generate a limited number of the hash values 272 because the number of unique TLS client sub-profiles may be limited due to the agnostic behavior of an IoT device operating as a TLS client.

Advantageously, the hash generator 240, and/or, more generally, the telemetry controller 102, may generate the hash value(s) 272 of TLS profiles to identify unique TLS profiles because an IoT device as identified by a model, manufacturer, and/or type of the IoT device may exhibit substantially similar exchanges of TLS parameters with a TLS server. For example, a first instance of the first IoT device 104 and a second instance of the first IoT device 104 may execute applications built to use an SSL library provided by a vendor of the first and second instances of the first IoT device 104. In some such examples, the instances of the first IoT device 104 may have a limited and/or repetitive TLS footprint by causing a minimal or reduced number of TLS client sub-profiles to be generated. In some such examples, the hash generator 240 may generate a limited number of the hash values 272 because the number of unique TLS client sub-profiles may be limited due to IoT devices having the same model, manufacturer, and/or type having substantially similar behavior when operating as a TLS client.

In some examples, the hash generator 240 implements example means for generating (e.g., second means for generating). For example, the second means for generating may be implemented by executable instructions such as that implemented by at least block 712 of FIG. 7 and/or block 1110 of FIG. 11. In some examples, the executable instructions of block 712 of FIG. 7 and/or block 1110 of FIG. 11 may be executed on at least one processor such as the example processor 1212 of FIG. 12. In other examples, the second means for generating is implemented by hardware logic, hardware implemented state machines, logic circuitry, and/or any other combination of hardware, software, and/or firmware. For example, the second means for generating may be implemented by at least one hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, the second means for generating is to generate a hash value based on at least one of a TLS client sub-profile or a TLS server sub-profile. In some examples in which the hash value is a first hash value based on the TLS client sub-profile, the second means for generating is to, in response to the first hash value matching a second hash value of the plurality of the hash values, generate a third hash value based on the TLS server sub-profile, and the second hash value corresponds to a known TLS client sub-profile. In some examples in which the hash value is a first hash value, the second means for generating is to generate a second hash value based on the second TLS server sub-profile.

In the illustrated example of FIG. 2, the telemetry controller 102 includes the TLS profile comparator 250 to identify unique TLS profile(s) based on the hash value(s) 272. In some examples, the TLS profile comparator 250 selects a TLS client sub-profile to process. For example, the TLS profile comparator 250 may select a TLS client sub-profile of the first IoT device 104 to process. In some such examples, the TLS profile comparator 250 may compare a first hash value of the TLS client sub-profile to the hash values 272 of known TLS client sub-profiles. For example, the TLS profile comparator 250 may compare the first hash value to a plurality of the hash values 272 stored in the TLS sub-profile hash datastore 270. In some such examples, the hash values 272 may correspond to known or previously identified TLS client sub-profiles.

In some examples, the TLS profile comparator 250 determines whether the first hash value matches a hash value of a known TLS client sub-profile. For example, the TLS profile comparator 250 may determine that the first hash value does not match any of the hash values 272 stored in the TLS sub-profile hash datastore 270. In some such examples, the TLS profile comparator 250 may identify the TLS client sub-profile corresponding to the first hash value as a unique TLS profile based on the determination that the first hash value does not match any of the hash values 272. In some such examples, the TLS profile comparator 250 may identify a first TLS server sub-profile, a second TLS server sub-profile, etc., associated with the TLS client sub-profile as unique TLS profiles because the TLS client sub-profile is identified as a unique TLS profile.

In some examples, the TLS profile comparator 250 may determine that the first hash value matches a second hash value stored in the TLS sub-profile hash datastore 270. For example, the TLS profile comparator 250 may determine that the TLS client sub-profile corresponding to the first hash value is not unique a TLS profile because the first hash value has been previously calculated. In some such examples, the TLS profile comparator 250 may determine that one or more TLS server sub-profiles associated with the TLS client sub-profile may be unique even though the TLS client sub-profile is not unique. For example, the TLS profile comparator 250 may determine that the first IoT device 104 is communicating with a different one of the servers 118, 120, 122 than the first IoT device 104 previously communicated with.

In some examples, the TLS profile comparator 250 may determine that the first IoT device 104 has the TLS client sub-profile, a first TLS server sub-profile, and a second TLS server sub-profile. In some such examples, the hash generator 240 may generate a third hash value based on the first TLS server sub-profile and a fourth hash value based on the second TLS server sub-profile. In some such examples, the TLS profile comparator 250 may compare the third hash value and the fourth hash value to the hash values 272 stored in the TLS sub-profile hash datastore 270. In some such examples, the TLS profile comparator 250 may determine whether the third hash value and/or the fourth hash value match one(s) of the hash value(s) 272 stored in the TLS sub-profile hash datastore 270. In some such examples, in response to determining that the third hash value does not match any of the hash values 272, the TLS profile comparator 250 may identify the first TLS server sub-profile as a unique TLS profile. In some such examples, in response to determining that the fourth hash value does not match any of the hash values 272, the TLS profile comparator 250 may identify the second TLS server sub-profile as a unique TLS profile. In some such examples, the TLS profile comparator 250 may cause at least one of first TLS telemetry data associated with the first TLS server sub-profile or the second TLS telemetry data associated with the second TLS server sub-profile to be transmitted the central facility server 110. For example, the TLS profile comparator 250 may invoke the communication interface 210 to transmit the at least one of first TLS telemetry data associated with the first TLS server sub-profile or the second TLS telemetry data associated with the second TLS server sub-profile to the central facility server 110.

In some examples, in response to determining that the third hash value and the fourth hash value match one(s) of the hash values 272, the TLS profile comparator 250 may determine that the first TLS server sub-profile and the second TLS server sub-profile are not unique TLS profiles. In some examples, the TLS profile comparator 250 may discard telemetry data associated with the first TLS server sub-profile and the second TLS server sub-profile because the telemetry data has previously been analyzed and/or otherwise obtained by the telemetry controller 102. Advantageously, the TLS profile comparator 250 may substantially reduce a quantity of telemetry data to be transmitted to the central facility server 110 by identifying previously identified TLS profiles.

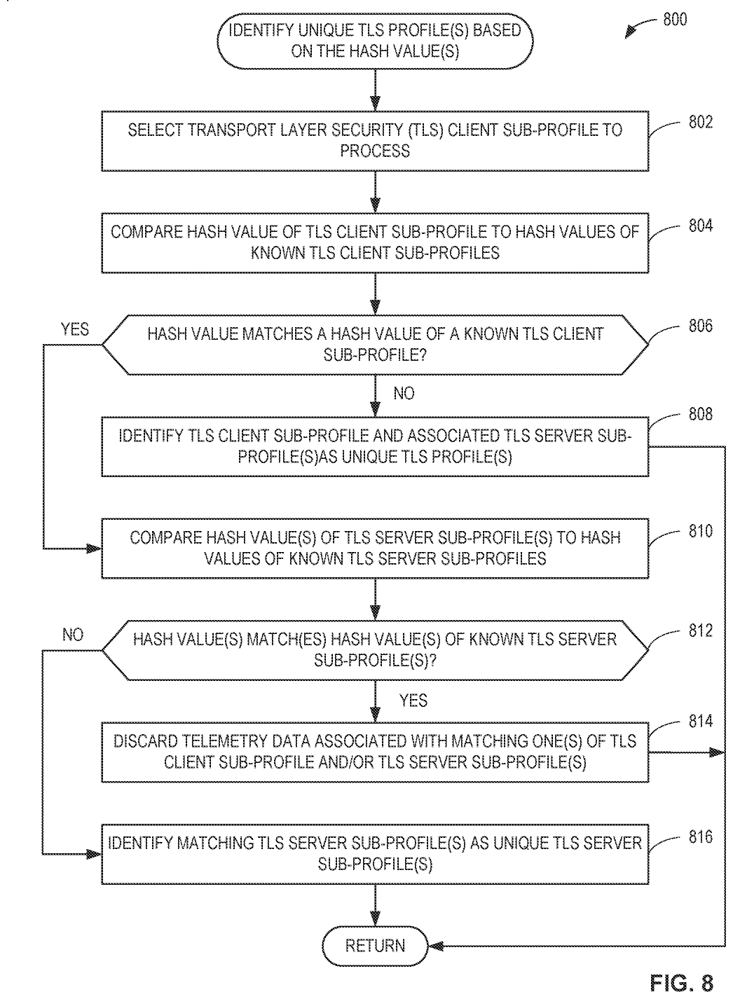

In some examples, the TLS profile comparator 250 implements example means for comparing. In some examples, the means for comparing is to compare the hash value to a plurality of hash values corresponding to known TLS profiles. For example, the means for comparing may be implemented by executable instructions such as that implemented by at least blocks 714, 716, 718 of FIG. 7, blocks 802, 804, 806, 808, 810, 812, 814, 816 of FIG. 8, and/or blocks 1110, 1112, 1114 of FIG. 11. In some examples, the executable instructions of blocks 714, 716, 718 of FIG. 7, blocks 802, 804, 806, 808, 810, 812, 814, 816 of FIG. 8, and/or blocks 1110, 1112, 1114 of FIG. 11 may be executed on at least one processor such as the example processor 1212 of FIG. 12. In other examples, the means for comparing is implemented by hardware logic, hardware implemented state machines, logic circuitry, and/or any other combination of hardware, software, and/or firmware. For example, the means for comparing may be implemented by at least one hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In the illustrated example of FIG. 2, the telemetry controller 102 includes the security handler 260 to execute one or mitigation actions, measures, or operations, one or more security actions, measures, or operations, etc., in response to a detection of malicious activity or behavior. For example, the security handler 260 of the first network device 112 may detect that the first IoT device 104 has been compromised and/or otherwise is undergoing or experiencing a malware attack, intrusion, etc., based on TLS flows transmitted by the first IoT device 104.

In some examples, the security handler 260 compares a data communication, such as a TLS flow, received from the IoT devices 104, 106, 108 to one or more firewall rules. For example, the security handler 260 may have and/or otherwise implement an allow or block list, a block or permit list, etc., based on an IP address, a MAC address, a TLS parameter, etc., associated with a TLS flow emanating from one(s) of the IoT devices 104, 106, 108.

In some examples, the security handler 260 detects malicious behavior associated with one(s) of the IoT devices 104, 106, 108 in response to executing one(s) of the more machine-learning model(s) 282. For example, the security handler 260 may execute one of the machine-learning model(s) 282 stored in the machine-learning model datastore 280. In some such examples, the communication interface 210 may obtain the machine-learning model(s) 282 from the central facility server 110. In some examples, the security handler 260 may invoke execution of the machine-learning model(s) 282 to process input data (e.g., one or more TLS parameters of a TLS flow, a hash value, a vendor identifier, an IP address, a MAC address, a serial number, a certificate, etc.) to generate an output (e.g., a label of a TLS flow as malicious or benign (e.g., legitimate, trustworthy, etc.)) based on patterns and/or associations previously learned by the machine-learning model(s) 282 via a training process. For example, the central facility server 110 may train the machine-learning model(s) 282 with data to recognize patterns and/or associations and follow such patterns and/or associations when processing input data such that other input(s) result in output(s) (e.g., machine-learning output(s)) consistent with the recognized patterns and/or associations.

In some examples, the security handler 260 executes the machine-learning model(s) 282 with a data communication as an input. For example, the security handler 260 may provide a TLS flow, one or more TLS parameters of the TLS flow, etc., as input(s) to the machine-learning model(s) 282 (e.g., machine-learning input(s)). In some such examples, the security handler 260 may execute the machine-learning model(s) 282 with the input(s) to generate an output (e.g., a machine-learning output), which may include a label of the data communication. For example, the security handler 260 may label the data communication as benign, legitimate, trustworthy, etc., or as compromised, malicious, not trustworthy, etc. In some such examples, the security handler 260 may identify the data communication as legitimate network behavior, legitimate computing behavior, etc.

In some examples, the security handler 260 determines whether malicious behavior is detected associated with the data communication. For example, the security handler 260 may determine that malicious behavior is detected in response to at least one of determining that one or more firewall rules have been violated or an output of the machine-learning model(s) 282 indicates that the data communication is indicative of malicious computing activity. In some such examples, in response to detecting malicious computing behavior or activity, the security handler 260 may execute one or more mitigation measures. For example, the security handler 260 may block or discard communications from a source (e.g., one(s) of the IoT devices 104, 106, 108, one(s) of the servers 118, 120, 122, etc.) of the malicious behavior, store the communications in a sandbox or trusted execution environment (TEE), or generate an alert to a user, a computing device, etc., indicative of the malicious behavior.

In some examples, the security handler 260 implements example means for executing. For example, the means for executing may be implemented by executable instructions such as that implemented by at least blocks 1116, 1118, 1120, 1122 of FIG. 11. In some examples, the executable instructions of blocks 1116, 1118, 1120, 1122 of FIG. 11 may be executed on at least one processor such as the example processor 1212 of FIG. 12. In other examples, the means for executing is implemented by hardware logic, hardware implemented state machines, logic circuitry, and/or any other combination of hardware, software, and/or firmware. For example, the means for executing may be implemented by at least one hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, the means for executing is to execute a machine-learning model to generate a machine-learning output based on at least one of the first telemetry data, the second telemetry data, the TLS client sub-profile, the TLS server sub-profile, or the hash value. In some examples, the means for executing is to, in response to a first determination that the machine-learning output is indicative of the client device being compromised, block communications from the client device. In some examples, the means for executing is to, in response to a second determination that the machine-learning output is indicative of malicious behavior associated with the first server, block communications from the first server.

In the illustrated example of FIG. 2, the telemetry controller 102 includes the TLS sub-profile hash datastore 270 to store data, such as the hash values 272 based on TLS sub-profiles (e.g., TLS client sub-profiles, TLS server sub-profiles, etc.). In some examples, the hash values 272 may be obtained from the central facility server 110. In some examples, the hash values 272 may be generated and/or otherwise output from the hash generator 240. The TLS sub-profile hash datastore 270 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The TLS sub-profile hash datastore 270 may additionally or alternatively be implemented by one or more double data rate (DDR) memories, such as DDR, DDR2, DDR3, DDR4, mobile DDR (mDDR), etc. The TLS sub-profile hash datastore 270 may additionally or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example the TLS sub-profile hash datastore 270 is illustrated as a single datastore, the TLS sub-profile hash datastore 270 may be implemented by any number and/or type(s) of datastores. Furthermore, the data, such as the hash value(s) 272, stored in the TLS sub-profile hash datastore 270 may be in any data format such as, for example, binary data, comma delimited data, tab delimited data, structured query language (SQL) structures, a table, a map, a grid, a datagram, a file, a document, a report, a list, etc.

In the illustrated example of FIG. 2, the telemetry controller 102 includes the machine-learning model datastore 280 to store one or more of the machine-learning models 282. For example, the machine-learning model datastore 280 may store one or more executable files that, when executed, implement and/or otherwise cause an execution of the machine-learning model(s) 282. In some examples, the machine-learning model(s) 282 may be obtained from the central facility server 110. In some examples, the machine-learning model(s) 282 may be generated and/or otherwise trained by the security handler 260. The machine-learning model datastore 280 may be implemented by a volatile memory (e.g., an SDRAM, a DRAM, an RDRAM, etc.) and/or a non-volatile memory (e.g., flash memory). The machine-learning model datastore 280 may additionally or alternatively be implemented by one or more DDR memories, such as DDR, DDR2, DDR3, DDR4, mDDR, etc. The machine-learning model datastore 280 may additionally or alternatively be implemented by one or more mass storage devices such as HDD(s), CD drive(s), DVD drive(s), SSD drive(s), etc. While in the illustrated example the machine-learning model datastore 280 is illustrated as a single datastore, the machine-learning model datastore 280 may be implemented by any number and/or type(s) of datastores. Furthermore, the machine-learning model(s) 282 stored in the machine-learning model datastore 280 may be in any data format such as, for example, binary data, a file (e.g., an executable file), etc.

In the illustrated example of FIG. 2, the telemetry controller 102 includes the network telemetry datastore 290 to store data, such as network telemetry data, which may include device identification data, one or more TLS parameters, TLS client hello messages, TLS server hello message, etc. In some examples, the data is obtained by the communication interface 210 from one(s) of the IoT devices 104, 106, 108 and/or one(s) of the servers 118, 120, 122. The network telemetry datastore 290 may be implemented by a volatile memory (e.g., an SDRAM, a DRAM, an RDRAM, etc.) and/or a non-volatile memory (e.g., flash memory). The network telemetry datastore 290 may additionally or alternatively be implemented by one or more DDR memories, such as DDR, DDR2, DDR3, DDR4, mDDR, etc. The network telemetry datastore 290 may additionally or alternatively be implemented by one or more mass storage devices such as HDD(s), CD drive(s), DVD drive(s), SSD drive(s), etc. While in the illustrated example the network telemetry datastore 290 is illustrated as a single datastore, the network telemetry datastore 290 may be implemented by any number and/or type(s) of datastores. Furthermore, the data stored in the network telemetry datastore 290 may be in any data format such as, for example, binary data, comma delimited data, tab delimited data, SQL structures, a table, a map, a grid, a datagram, a file, a document, a report, a list, etc.

While an example manner of implementing the telemetry controller 102 of FIG. 1 is illustrated in FIG. 2, one or more of the elements, processes and/or devices illustrated in FIG. 2 may be combined, divided, re-arranged, omitted, eliminated and/or implemented in any other way. Further, the example communication interface 210, the example device identifier 220, the example TLS profile generator 230, the example hash generator 240, the example TLS profile comparator 250, the example security handler 260, the example TLS sub-profile hash datastore 270, the example hash value(s) 272, the example machine-learning model datastore 280, the example machine-learning model(s) 282, the example network telemetry datastore 290, and the example bus 295, and/or, more generally, the example telemetry controller 102 of FIG. 1 may be implemented by hardware, software, firmware, and/or any combination of hardware, software, and/or firmware. Thus, for example, any of the example communication interface 210, the example device identifier 220, the example TLS profile generator 230, the example hash generator 240, the example TLS profile comparator 250, the example security handler 260, the example TLS sub-profile hash datastore 270, the example hash value(s) 272, the example machine-learning model datastore 280, the example machine-learning model(s) 282, the example network telemetry datastore 290, and the example bus 295, and/or, more generally, the example telemetry controller 102 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) (e.g., field programmable gate array(s) (FPGA(s))). When reading any of the apparatus or system claims of this patent to cover a purely software and/or firmware implementation, at least one of the example communication interface 210, the example device identifier 220, the example TLS profile generator 230, the example hash generator 240, the example TLS profile comparator 250, the example security handler 260, the example TLS sub-profile hash datastore 270, the example hash value(s) 272, the example machine-learning model datastore 280, the example machine-learning model(s) 282, the example network telemetry datastore 290, and/or the example bus 295 is/are hereby expressly defined to include a non-transitory computer readable storage device or storage disk such as a memory, a DVD, a CD, a Blu-ray disk, etc., including the software and/or firmware. Further still, the example telemetry controller 102 of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

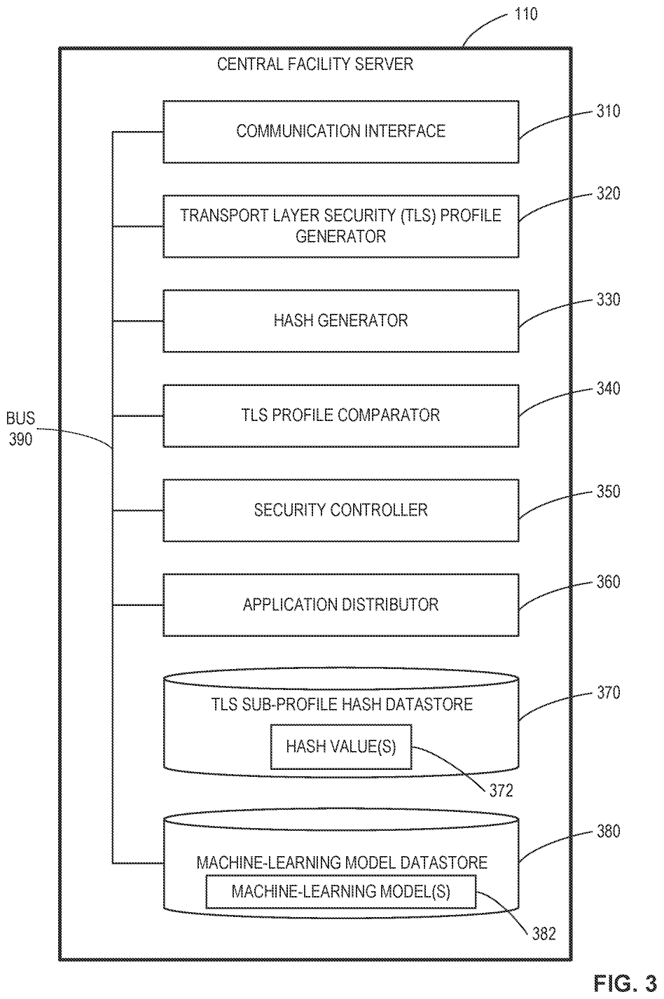

FIG. 3 is an example implementation of the central facility server 110 of FIG. 1. The central facility server 110 of FIG. 3 includes an example communication interface 310, an example Transport Layer Security (TLS) profile generator 320, an example hash generator 330, an example TLS profile comparator 340, an example security controller 350, an example application distributor 360, an example TLS sub-profile hash datastore 370, an example machine-learning model datastore 380, and an example bus 390. In this example, the TLS sub-profile hash datastore 370 includes example hash value(s) 372. In this example, the machine-learning model datastore 380 includes example machine-learning model(s) 382.

In the illustrated example of FIG. 3, the communication interface 310, the TLS profile generator 320, the hash generator 330, the TLS profile comparator 340, the security controller 350, the application distributor 360, the TLS sub-profile hash datastore 370, and the machine-learning model datastore 380 are in communication with one(s) of each other via the bus 390. For example, the bus 390 may implement at least one of an I2C bus, a SPI bus, or a PCI bus. Additionally or alternatively, the bus 390 may implement any other type of computing or electrical bus.

In the illustrated example of FIG. 3, the central facility server 110 includes the communication interface 310 to receive and/or otherwise obtain communications from the telemetry controller 102 via the network 124. In some examples, the communication interface 310 may be an example implementation of the communication interface 210 of FIG. 2. For example, the communication interface 310 may execute and/or otherwise implement functionality described above in connection with the communication interface 210 of FIG. 2.

In some examples, the communication interface 310 may implement a web server that transmits data to the network 124 and/or receives data from the network 124. In some examples, the communication interface 310 determines whether a communication (e.g., a TLS flow, a data communication including a TLS flow and/or one or more TLS parameters, etc.) includes TLS client telemetry data and/or TLS server telemetry data. For example, the communication interface 310 may determine that a TLS flow includes TLS client telemetry data based on the TLS flow including one or more TLS parameters associated with a TLS client. In some examples, the communication interface 310 may determine that a TLS flow includes TLS server telemetry data based on the TLS flow including one or more TLS parameters associated with a TLS server. In some examples, the communication interface 310 may determine that a TLS flow includes a hash value based on a TLS client sub-profile.

In the illustrated example of FIG. 3, the central facility server 110 includes the TLS profile generator 320 to generate a TLS profile based on TLS client telemetry data and/or TLS server telemetry data. In some examples, the TLS profile generator 320 may be an example implementation of the TLS profile generator 230 of FIG. 2. For example, the TLS profile generator 320 may execute and/or otherwise implement functionality described above in connection with the TLS profile generator 230 of FIG. 2.

In some examples, the TLS profile generator 320 may generate the TLS profile to include at least one of a TLS client sub-profile or a TLS server sub-profile. For example, the TLS profile generator 320 may generate a TLS client sub-profile based on one or more TLS parameters associated with a TLS client hello message. In some examples, the TLS profile generator 320 may generate a TLS server sub-profile based on one or more TLS parameters associated with a TLS server hello message.

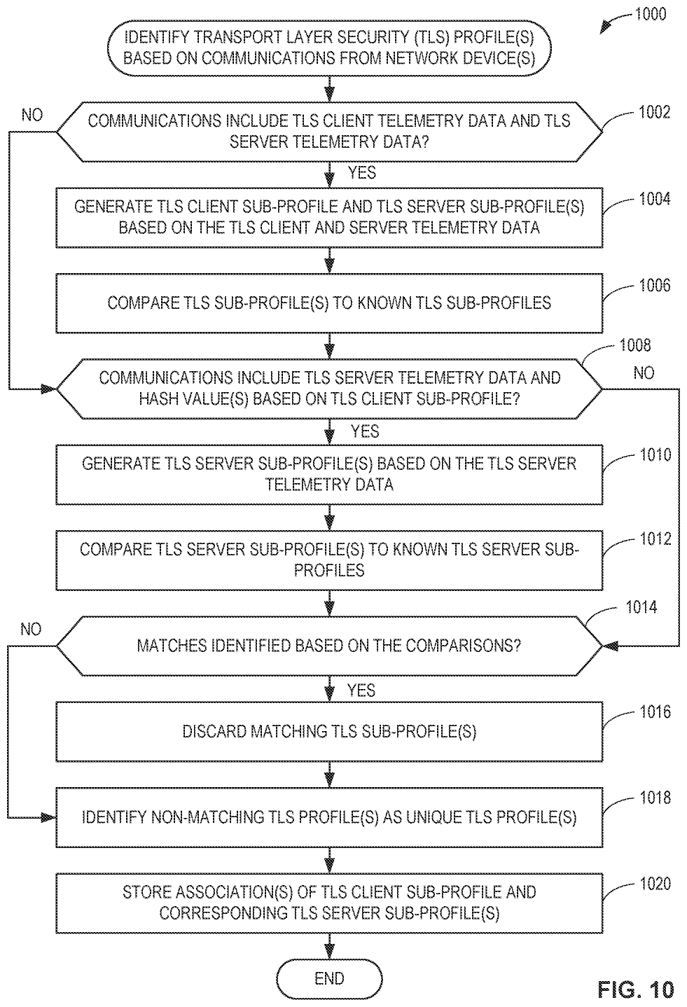

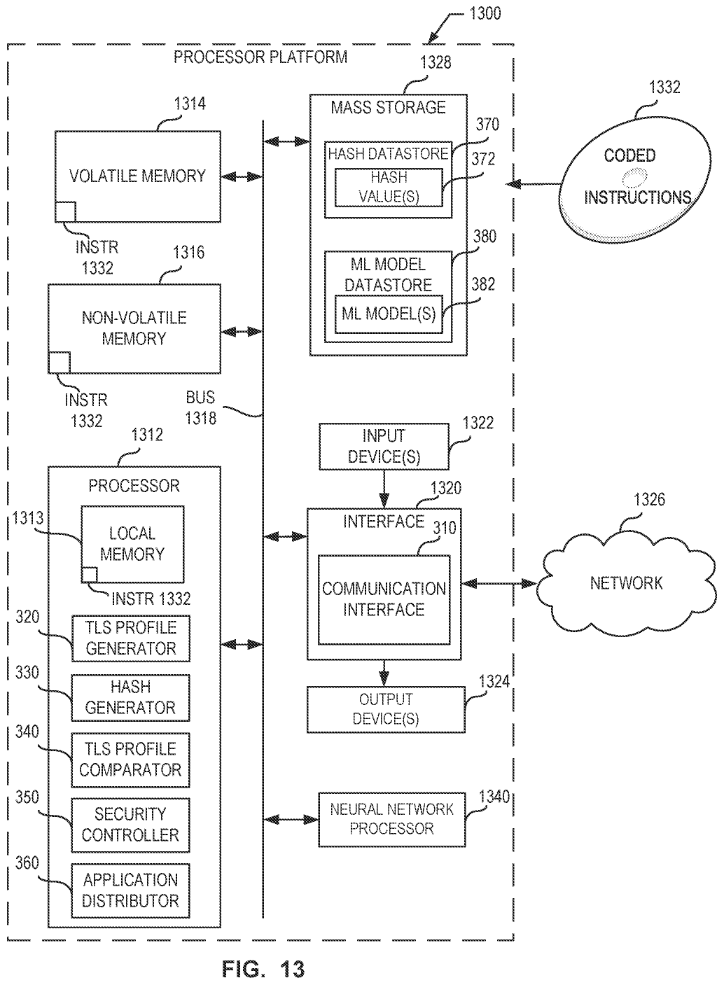

In some examples, the TLS profile generator 320 implements example means for generating (e.g., first means for generating). For example, the first means for generating may be implemented by executable instructions such as that implemented by at least blocks 1004, 1010 of FIG. 10. In some examples, the executable instructions of blocks 1004, 1010 may be executed on at least one processor such as the example processor 1312 of FIG. 13. In other examples, the first means for generating is implemented by hardware logic, hardware implemented state machines, logic circuitry, and/or any other combination of hardware, software, and/or firmware. For example, the first means for generating may be implemented by at least one hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, the first means for generating is to generate a Transport Layer Security (TLS) profile based on telemetry data obtained from a network device, the telemetry data associated with at least one of a client device in communication with a network device or a server in communication with the network device, and the TLS profile including a TLS parameter of a TLS message. In some examples in which the TLS message is a first TLS message, the telemetry data is first telemetry data based on the first TLS message transmitted from the client device to the server, the TLS profile is a TLS client sub-profile, the TLS parameter is a first TLS parameter, and the hash value is a first hash value based on the TLS client sub-profile, the first means for generating is to, in response to the first hash value matching a second hash value of the plurality of the hash values, generate a TLS server sub-profile based on second telemetry data obtained from the network device, the second hash value corresponding to a known TLS client sub-profile, the second telemetry data based on a second TLS message transmitted from the server to the client device, and the second TLS message including a second TLS parameter.

In the illustrated example of FIG. 3, the central facility server 110 includes the hash generator 330 to generate the hash value(s) 372 of at least one of a TLS client sub-profile or TLS server sub-profile(s). In some examples, the hash generator 330 stores the hash value(s) 372 in the TLS sub-profile hash datastore 370. For example, the hash generator 330 may generate a hash value of a TLS profile by executing a hash algorithm (e.g., an SHA algorithm, an SHA-1 algorithm, an SHA-2 algorithm (e.g., SHA-256, SHA-384, SHA-512, etc., algorithms), etc.) on one or more TLS parameters of the TLS profile. In some examples, the hash generator 330 may generate, calculate, and/or otherwise determine a first hash value by executing a hash algorithm on one or more TLS parameters of a TLS client sub-profile. In some examples, the hash generator 330 may generate, calculate, and/or otherwise determine a second hash value by executing a hash algorithm on one or more TLS parameters of a first TLS server sub-profile associated with the TLS client sub-profile. In some examples, the hash generator 330 may generate, calculate, and/or otherwise determine a third hash value by executing a hash algorithm on one or more TLS parameters of a second TLS server sub-profile associated with the TLS client sub-profile and/or the first TLS server sub-profile.

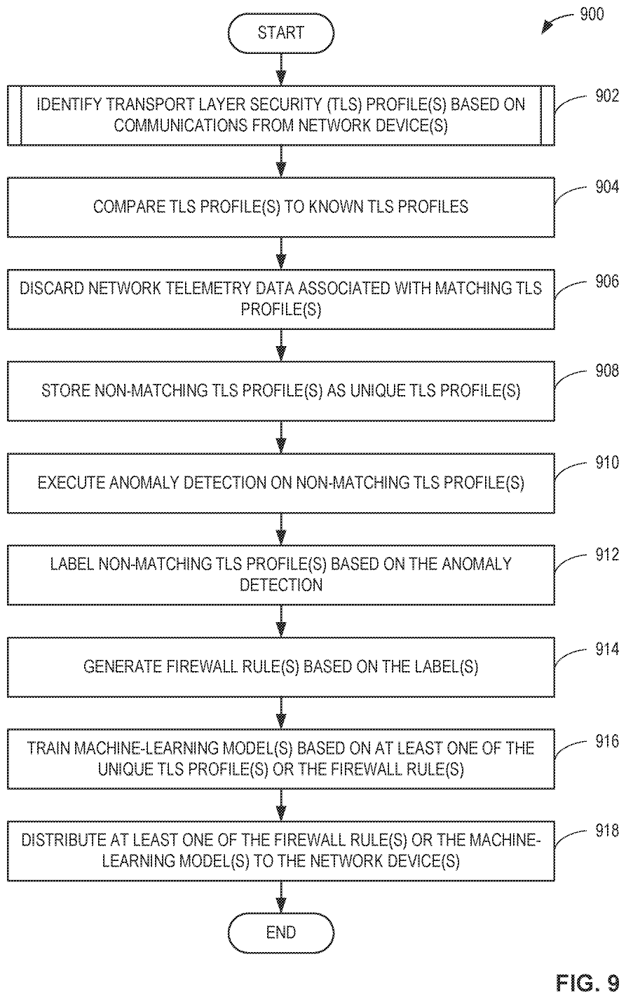

In some examples, the hash generator 330 implements example means for generating (e.g., second means for generating). In some examples, the second means for generating is to generate a hash value based on a TLS profile (e.g., a TLS client sub-profile, a TLS server sub-profile, etc.). For example, the second means for generating may generate a first hash value based on a TLS client sub-profile, a second hash value based on a TLS server sub-profile, etc. For example, the second means for generating may be implemented by executable instructions such as that implemented by at least block 904 of FIG. 9. In some examples, the executable instructions of block 904 may be executed on at least one processor such as the example processor 1312 of FIG. 13. In other examples, the second means for generating is implemented by hardware logic, hardware implemented state machines, logic circuitry, and/or any other combination of hardware, software, and/or firmware. For example, the second means for generating may be implemented by at least one hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In the illustrated example of FIG. 3, the central facility server 110 includes the TLS profile comparator 340 to identify unique TLS profile(s) based on the hash value(s) 372. For example, the TLS profile comparator 340 may compare TLS profile(s) to known TLS profiles and identify whether there are any matches based on the comparison. In some examples, the TLS profile comparator 340 selects a TLS client sub-profile to process. For example, the TLS profile comparator 340 may select a TLS client sub-profile associated with the first IoT device 104 to process. In some such examples, the TLS profile comparator 340 may compare a first hash value based on the TLS client sub-profile to the hash values 372 of known TLS client sub-profiles. For example, the TLS profile comparator 340 may compare the first hash value to a plurality of the hash values 372 stored in the TLS sub-profile hash datastore 370. In some such examples, the hash values 372 may correspond to known or previously identified TLS client sub-profiles.

In some examples, the TLS profile comparator 340 determines whether the first hash value matches a hash value of a known TLS client sub-profile. For example, the TLS profile comparator 340 may determine that the first hash value does not match any of the hash values 372 stored in the TLS sub-profile hash datastore 370. In some such examples, the TLS profile comparator 340 may identify the TLS client sub-profile corresponding to the first hash value as a unique TLS profile based on the determination that the first hash value does not match any of the hash values 372. In some such examples, the TLS profile comparator 340 may store the first hash value as one of the hash value(s) 372 in response to determining that the first hash value corresponds to a unique TLS profile.

In some examples, the TLS profile comparator 340 may determine that the first hash value matches a second hash value stored in the TLS sub-profile hash datastore 370. For example, the TLS profile comparator 340 may determine that the TLS client sub-profile corresponding to the first hash value is not a unique TLS profile because the first hash value has been previously identified. In some such examples, the TLS profile comparator 340 may discard and/or otherwise not store the first hash value as one of the hash value(s) 372 in response to determining that the first hash value does not correspond to a unique TLS profile.

In some examples, the TLS profile comparator 340 may determine that one or more TLS server sub-profiles associated with the TLS client sub-profile may be unique even though the TLS client sub-profile is not unique. For example, the TLS profile comparator 340 may determine that the first IoT device 104 is communicating with a different one of the servers 118, 120, 122 than the first IoT device 104 previously communicated with. In some such examples, the TLS profile comparator 340 may determine that the first IoT device 104 has the TLS client sub-profile, a first TLS server sub-profile, and a second TLS server sub-profile. In some such examples, the hash generator 330 may generate a third hash value based on the first TLS server sub-profile and a fourth hash value based on the second TLS server sub-profile. In some such examples, the TLS profile comparator 340 may compare the third hash value and the fourth hash value to the hash values 372 stored in the TLS sub-profile hash datastore 370. In some such examples, the TLS profile comparator 340 may determine whether the third hash value and/or the fourth hash value match one(s) of the hash value(s) 372 stored in the TLS sub-profile hash datastore 370. In some such examples, in response to determining that the third hash value does not match any of the hash values 372, the TLS profile comparator 340 may identify the first TLS server sub-profile as a unique TLS profile. In some such examples, in response to determining that the fourth hash value does not match any of the hash values 372, the TLS profile comparator 340 may identify the second TLS server sub-profile as a unique TLS profile. In some such examples, the TLS profile comparator 340 may store the third hash value as one of the hash value(s) 372 in response to determining that the third hash value corresponds to a unique TLS profile. In some such examples, the TLS profile comparator 340 may store the fourth hash value as one of the hash value(s) 372 in response to determining that the fourth hash value corresponds to a unique TLS profile. In some such examples, the TLS profile comparator 340 may store association(s) of at least one of the third hash value or the fourth hash value and the first hash value. For example, the TLS profile comparator 340 may store an association of the TLS client sub-profile and at least one of the first TLS server sub-profile or the second TLS server sub-profile to improve indexing and/or searching operations of the TLS sub-profile hash datastore 370.

In some examples, in response to determining that the third hash value and the fourth hash value match one(s) of the hash values 372, the TLS profile comparator 340 may determine that the first TLS server sub-profile and the second TLS server sub-profile are not unique TLS profiles. In some examples, the TLS profile comparator 340 may discard telemetry data associated with the first TLS server sub-profile and the second TLS server sub-profile because the telemetry data has previously been analyzed and/or otherwise obtained by the central facility server 110. Advantageously, the TLS profile comparator 340 may substantially reduce a quantity of telemetry data to be stored by the central facility server 110 by identifying previously identified TLS profiles.

In some examples, the TLS profile comparator 340 causes the hash value(s) 372 to be transmitted to the telemetry controller 102. For example, the TLS profile comparator 340 may invoke the communication interface 310 to transmit the hash value(s) 372 to the telemetry controller 102 to be stored as the hash value(s) 272 of FIG. 2.

In some examples, the TLS profile comparator 340 implements example means for identifying. For example, the means for identifying may be implemented by executable instructions such as that implemented by at least blocks 902, 904, 906, 908 of FIG. 10 and/or blocks 1006, 1012, 1014, 1016, 1018, 1020 of FIG. 10. In some examples, the executable instructions of blocks 902, 904, 906, 908 of FIG. 10 and/or blocks 1006, 1012, 1014, 1016, 1018, 1020 of FIG. 10 may be executed on at least one processor such as the example processor 1312 of FIG. 13. In other examples, the means for identifying is implemented by hardware logic, hardware implemented state machines, logic circuitry, and/or any other combination of hardware, software, and/or firmware. For example, the means for identifying may be implemented by at least one hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, the means for identifying is to identify a TLS profile as a unique TLS profile based on comparisons of a hash value to a plurality of hash values corresponding to known TLS profiles. In some examples in which telemetry data is based on the TLS message transmitted from a client device to a server, the TLS profile is a TLS client sub-profile, and the hash value is a first hash value based on the TLS client sub-profile, the means for identifying is to, in response to the first hash value not matching a second hash value of the plurality of the hash values, identify the TLS client sub-profile as the unique TLS profile, and store the first hash value (e.g., store the first hash value in a datastore). In some examples, the means for identifying is to identify a TLS server sub-profile as a unique TLS profile, and store an association of the TLS server sub-profile.

In the illustrated example of FIG. 3, the central facility server 110 includes the security controller 350 to execute security tasks (e.g., network security tasks, information technology security tasks, computing security tasks, etc.) and/or generate mitigation measures that may be invoked by the telemetry controller 102. In some examples, the security controller 350 executes anomaly detection on TLS profile(s). For example, the security controller 350 may provide a TLS client sub-profile and/or TLS server sub-profile(s) as input(s) to anomaly detection models. In some such examples, the security controller 350 may execute the anomaly detection models to determine whether the TLS client sub-profile and/or the TLS server sub-profile(s) are associated with an attack, such as zero-day, botnet, spam, and/or reconnaissance attacks. For example, the security controller 350 may execute the anomaly detection models to detect unusual network behavior, identify threats, etc., by applying behavior-based algorithms to TLS parameter(s) of the TLS sub-profiles.

In some example, the security controller 350 may label a TLS profile based on the anomaly detection. For example, the security controller 350 may execute the anomaly detection models to output a label, such as a benign or trustworthy label or a compromised or malicious label. In some such examples, the security controller 350 may generate one or more firewall rules based on the labels. For example, the security controller 350 may generate a first firewall rule to block communications from a TLS profile having a compromised or malicious label. In some examples, the security controller 350 may generate a second firewall rule to allow communications from a TLS profile having a benign or trustworthy label.

In some examples, the security controller 350 trains the machine-learning model(s) 382 based on at least one of the unique TLS profile(s) or the firewall rules. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the machine-learning model(s) 382 may be trained with data to recognize patterns and/or associations and follow such patterns and/or associations when processing input data such that other input(s) result in output(s) consistent with the recognized patterns and/or associations.

Many different types of machine-learning models and/or machine-learning architectures exist. In some examples, the security controller 350 generates the machine-learning model(s) 382 as neural network model(s). The security controller 350 may invoke the communication interface 310 to transmit the machine-learning model(s) 382 to the telemetry controller 102 of FIGS. 1 and/or 2. Using a neural network model enables the telemetry controller 102 to determine whether a TLS flow including one or more TLS parameters is associated with malicious behavior of a compromised device or legitimate behavior of a secure or non-compromised device. In general, machine-learning models/architectures that are suitable to use in the example approaches disclosed herein include recurrent neural networks. However, other types of machine learning models could additionally or alternatively be used such as supervised learning artificial neural network models, clustering models, classification models, etc., and/or a combination thereof. Example supervised learning artificial neural network models can include two-layer (2-layer) radial basis neural networks (RBN), learning vector quantization (LVQ) classification neural networks, etc. Example clustering models can include k-means clustering, hierarchical clustering, mean shift clustering, density-based clustering, etc. Example classification models can include logistic regression, support-vector machine or network, Naive Bayes, etc. In some examples, the security controller 350 may implement one(s) of the machine-learning model(s) 382 as lightweight machine-learning models.

In general, implementing a ML/AI system involves two phases, a learning/training phase and an inference phase. In the learning/training phase, a training algorithm is used to train the machine-learning model(s) 382 to operate in accordance with patterns and/or associations based on, for example, training data. In general, the machine-learning model(s) 382 include(s) internal parameters that guide how input data is transformed into output data, such as through a series of nodes and connections within the machine-learning model(s) 382 to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, the security controller 350 may invoke supervised training to use inputs and corresponding expected (e.g., labeled) outputs to select parameters (e.g., by iterating over combinations of select parameters) for the machine-learning model(s) 382 that reduce model error. As used herein, labeling refers to an expected output of the machine learning model (e.g., a classification, an expected output value, etc.). Alternatively, the security controller 350 may invoke unsupervised training (e.g., used in deep learning, a subset of machine learning, etc.) that involves inferring patterns from inputs to select parameters for the machine-learning model(s) 382 (e.g., without the benefit of expected (e.g., labeled) outputs).

In some examples, the security controller 350 trains the machine-learning model(s) 382 using unsupervised clustering of operating observables. For example, the operating observables may include a TLS parameter and/or a vendor identifier, an IP address, a MAC address, a serial number, a certificate, etc., of a device (e.g., an enterprise device, an IoT device, etc.). However, the security controller 350 may additionally or alternatively use any other training algorithm such as stochastic gradient descent, Simulated Annealing, Particle Swarm Optimization, Evolution Algorithms, Genetic Algorithms, Nonlinear Conjugate Gradient, etc.

In some examples, the security controller 350 may train the machine-learning model(s) 382 until the level of error is no longer reducing. In some examples, the security controller 350 may train the machine-learning model(s) 382 locally on the central facility server 110 and/or remotely at an external computing system (e.g., one(s) of the network devices 112, 114, 116 of FIG. 1, the telemetry controller 102, etc.) communicatively coupled to the central facility server 110. In some examples, the security controller 350 trains the machine-learning model(s) 382 using hyperparameters that control how the learning is performed (e.g., a learning rate, a number of layers to be used in the machine learning model, etc.). In some examples, the security controller 350 may use hyperparameters that control model performance and training speed such as the learning rate and regularization parameter(s). The security controller 350 may select such hyperparameters by, for example, trial and error to reach an optimal model performance. In some examples, the security controller 350 utilizes Bayesian hyperparameter optimization to determine an optimal and/or otherwise improved or more efficient network architecture to avoid model overfitting and improve the overall applicability of the machine-learning model(s) 382. Alternatively, the security controller 350 may use any other type of optimization. In some examples, the security controller 350 may perform re-training. The security controller 350 may execute such re-training in response to override(s) by a user of the central facility server 110, a receipt of new training data (e.g., a TLS profile, one or more TLS parameters, etc., obtained by the communication interface 310).

In some examples, the security controller 350 facilitates the training of the machine-learning model(s) 382 using training data. In some examples, the security controller 350 utilizes training data that originates from locally generated data, such as one(s) of the hash value(s) 372 generated by the hash generator 330, TLS profiles generated by the TLS profile comparator 340, etc. In some examples, the security controller 350 utilizes training data that originates from externally generated data, such as one(s) of the hash value(s) 272 generated by the hash generator 240, TLS profiles generated by the TLS profile comparator 250, network telemetry data from the network telemetry datastore 290, etc. In some examples where supervised training is used, the security controller 350 may label the training data (e.g., label training data or portion(s) thereof as benign or malicious). Labeling is applied to the training data by a user manually or by an automated data pre-processing system. In some examples, the security controller 350 may pre-process the training data using, for example, an interface (e.g., the communication interface 310) to determine one or more TLS parameters based on the network telemetry data. In some examples, the security controller 350 sub-divides the training data into a first portion of data for training the machine-learning model(s) 382, and a second portion of data for validating the machine-learning model(s) 382.

Once training is complete, the security controller 350 may deploy the machine-learning model(s) 382 for use as an executable construct that processes an input and provides an output based on the network of nodes and connections defined in the machine-learning model(s) 382. The security controller 350 may store the machine-learning model(s) 382 in the machine-learning model datastore 380. In some examples, the security controller 350 may invoke the communication interface 310 to transmit the machine-learning model(s) 382 to the telemetry controller 102, which may store the machine-learning model(s) 382 as the machine-learning model(s) 282. In some such examples, in response to transmitting the machine-learning model(s) 382 to the telemetry controller 102, the security controller 350 may cause the telemetry controller 102 to execute the machine-learning model(s) 382 to improve security of the network devices 112, 114, 116.

Once trained, the deployed one(s) of the machine-learning model(s) 382 may be operated in an inference phase to process data. In the inference phase, data to be analyzed (e.g., live data) is input to the machine-learning model(s) 382, and the machine-learning model(s) 382 execute(s) to create an output. This inference phase can be thought of as the AI “thinking” to generate the output based on what it learned from the training (e.g., by executing the machine-learning model(s) 382 to apply the learned patterns and/or associations to the live data). In some examples, input data undergoes pre-processing before being used as an input to the machine-learning model(s) 382. Moreover, in some examples, the output data may undergo post-processing after it is generated by the machine-learning model(s) 382 to transform the output into a useful result (e.g., a display of data, an instruction to be executed by a machine, etc.).

In some examples, output of the deployed one(s) of the machine-learning model(s) 382 may be captured and provided as feedback. By analyzing the feedback, an accuracy of the deployed one(s) of the machine-learning model(s) 382 can be determined. If the feedback indicates that the accuracy of the deployed model is less than a threshold or other criterion, training of an updated model can be triggered using the feedback and an updated training data set, hyperparameters, etc., to generate an updated, deployed model.

In some examples, the security controller 350 implements example means for executing. For example, the means for executing may be implemented by executable instructions such as that implemented by at least blocks 910, 912, 914, 916 of FIG. 9 and/or blocks 1102, 1104 of FIG. 11. In some examples, the executable instructions of blocks 910, 912, 914, 916 of FIG. 9 and/or blocks 1102, 1104 of FIG. 11 may be executed on at least one processor such as the example processor 1312 of FIG. 13. In other examples, the means for executing is implemented by hardware logic, hardware implemented state machines, logic circuitry, and/or any other combination of hardware, software, and/or firmware. For example, the means for executing may be implemented by at least one hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, the means for executing is to execute anomaly detection on a TLS client sub-profile and/or a TLS server sub-profile. In some examples, the means for executing is to, in response to identifying the TLS client sub-profile as associated with a malware attack, label a first hash value as malicious, and the first hash value corresponding to the TLS client-sub-profile. In some examples, the means for executing is to, in response to identifying the TLS server sub-profile as associated with the malware attack, label a second hash value as malicious, and the second hash value corresponding to the TLS server sub-profile.

In some examples, the means for executing is to, in response to identifying the TLS client sub-profile as associated with legitimate network behavior, label the first hash value as legitimate. In some examples, the means for executing is to, in response to identifying the TLS server sub-profile as associated with the legitimate network behavior, label the second hash value as legitimate. In some examples, the means for executing is to generate one or more firewall rules based on at least one of the labeling of the first hash value or the second hash value. In some examples, the means for executing is to identify a type of a client device based on telemetry data, and identify at least one of a firewall rule or a machine-learning model based on the type of the client device.

In the illustrated example of FIG. 3, the central facility server 110 includes the application distributor 360 to distribute at least one of one or more firewall rules or the machine-learning model(s) 382 to the telemetry controller 102. For example, the application distributor 360 may distribute the at least one of the one or more firewall rules or the machine-learning model(s) 382 as separate applications (e.g., executables or executable constructs) or as part of the same application.

In some examples, the application distributor 360 distributes the at least one of one or more firewall rules or the machine-learning model(s) 382 based on a device type. For example, the device identifier 220 may identify a type of the first IoT device 104. In some such examples, the device identifier 220 may invoke the communication interface 210 to request the application distributor 360 for firewall rule(s) and/or a machine-learning model that corresponds to the type of the first IoT device 104. In some such examples, the application distributor 360 may identify firewall rule(s) and/or one(s) of the machine-learning model(s) 382 that are generated based on the type of the first IoT device 104. In some such examples, the application distributor 360 may identify the firewall rule(s) and/or the one(s) of the machine-learning model(s) 382 by mapping a TLS profile and/or a hash value of the TLS profile of the first IoT device 104 to corresponding one(s) of the firewall rule(s) and/or the one(s) of the machine-learning model(s) 382. For example, the firewall rule(s) and/or one(s) of the machine-learning model(s) 382 may be generated based on the TLS profile and/or the hash value of the TLS profile.

In some examples, the application distributor 360 implements example means for distributing. For example, the means for distributing may be implemented by executable instructions such as that implemented by at least block 918 of FIG. 9 and/or block 1104 of FIG. 11. In some examples, the executable instructions of block 918 of FIG. 9 and/or block 1104 of FIG. 11 may be executed on at least one processor such as the example processor 1312 of FIG. 13. In other examples, the means for distributing is implemented by hardware logic, hardware implemented state machines, logic circuitry, and/or any other combination of hardware, software, and/or firmware. For example, the means for distributing may be implemented by at least one hardware circuit (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware, but other structures are likewise appropriate.

In some examples, the means for distributing is to identify a type of a client device based on telemetry data, identify at least one of a firewall rule or a machine-learning model based on the type of the client device, and distribute the at least one of the firewall rule or the machine-learning model to a network device, and the network device to execute a network security task based on the at least one of the firewall rule or the machine-learning model.

In the illustrated example of FIG. 3, the central facility server 110 includes the TLS sub-profile hash datastore 370 to store data, such as the hash values 372 based on TLS sub-profiles (e.g., TLS client sub-profiles, TLS server sub-profiles, etc.). In some examples, the hash values 372 may be obtained from the telemetry controller 102. In some examples, the hash values 372 may be generated and/or otherwise output from the hash generator 330. The TLS sub-profile hash datastore 370 may be implemented by a volatile memory (e.g., an SDRAM, a DRAM, an RDRAM, etc.) and/or a non-volatile memory (e.g., flash memory). The TLS sub-profile hash datastore 370 may additionally or alternatively be implemented by one or more DDR memories, such as DDR, DDR2, DDR3, DDR4, mDDR, etc. The TLS sub-profile hash datastore 370 may additionally or alternatively be implemented by one or more mass storage devices such as HDD(s), CD drive(s), DVD drive(s), SSD drive(s), etc. While in the illustrated example the TLS sub-profile hash datastore 370 is illustrated as a single datastore, the TLS sub-profile hash datastore 370 may be implemented by any number and/or type(s) of datastores. Furthermore, the data, such as the hash value(s) 372, stored in the TLS sub-profile hash datastore 370 may be in any data format such as, for example, binary data, comma delimited data, tab delimited data, SQL structures, a table, a map, a grid, a datagram, a file, a document, a report, a list, etc.

In the illustrated example of FIG. 2, the telemetry controller 102 includes the machine-learning model datastore 380 to store one or more of the machine-learning models 382. For example, the machine-learning model datastore 380 may store one or more executable files that, when executed, implement and/or otherwise cause an execution of the machine-learning model(s) 382. The machine-learning model datastore 380 may be implemented by a volatile memory (e.g., an SDRAM, a DRAM, an RDRAM, etc.) and/or a non-volatile memory (e.g., flash memory). The machine-learning model datastore 380 may additionally or alternatively be implemented by one or more DDR memories, such as DDR, DDR2, DDR3, DDR4, mDDR, etc. The machine-learning model datastore 380 may additionally or alternatively be implemented by one or more mass storage devices such as HDD(s), CD drive(s), DVD drive(s), SSD drive(s), etc. While in the illustrated example the machine-learning model datastore 380 is illustrated as a single datastore, the machine-learning model datastore 380 may be implemented by any number and/or type(s) of datastores. Furthermore, the machine-learning model(s) 382 stored in the machine-learning model datastore 380 may be in any data format such as, for example, binary data, a file (e.g., an executable file), etc.

While an example manner of implementing the central facility server 110 of FIG. 1 is illustrated in FIG. 3, one or more of the elements, processes and/or devices illustrated in FIG. 3 may be combined, divided, re-arranged, omitted, eliminated and/or implemented in any other way. Further, the example communication interface 310, the example TLS profile generator 320, the example hash generator 330, the example TLS profile comparator 340, the example security controller 350, the example application distributor 360, the example TLS sub-profile hash datastore 370, the example hash value(s) 372, the example machine-learning model datastore 380, the example machine-learning model(s) 382, and the example bus 390, and/or, more generally, the example central facility server 110 of FIG. 1 may be implemented by hardware, software, firmware, and/or any combination of hardware, software, and/or firmware. Thus, for example, any of the example communication interface 310, the example TLS profile generator 320, the example hash generator 330, the example TLS profile comparator 340, the example security controller 350, the example application distributor 360, the example TLS sub-profile hash datastore 370, the example hash value(s) 372, the example machine-learning model datastore 380, the example machine-learning model(s) 382, and the example bus 390, and/or, more generally, the example central facility server 110 could be implemented by one or more analog or digital circuit(s), logic circuits, programmable processor(s), programmable controller(s), GPU(s), DSP(s), ASIC(s), PLD(s), and/or FPLD(s) (e.g., FPGA(s)). When reading any of the apparatus or system claims of this patent to cover a purely software and/or firmware implementation, at least one of the example communication interface 310, the example TLS profile generator 320, the example hash generator 330, the example TLS profile comparator 340, the example security controller 350, the example application distributor 360, the example TLS sub-profile hash datastore 370, the example hash value(s) 372, the example machine-learning model datastore 380, the example machine-learning model(s) 382, and/or the example bus 390 is/are hereby expressly defined to include a non-transitory computer readable storage device or storage disk such as a memory, a DVD, a CD, a Blu-ray disk, etc., including the software and/or firmware. Further still, the example central facility server 110 of FIG. 1 may include one or more elements, processes and/or devices in addition to, or instead of, those illustrated in FIG. 3, and/or may include more than one of any or all of the illustrated elements, processes and devices.

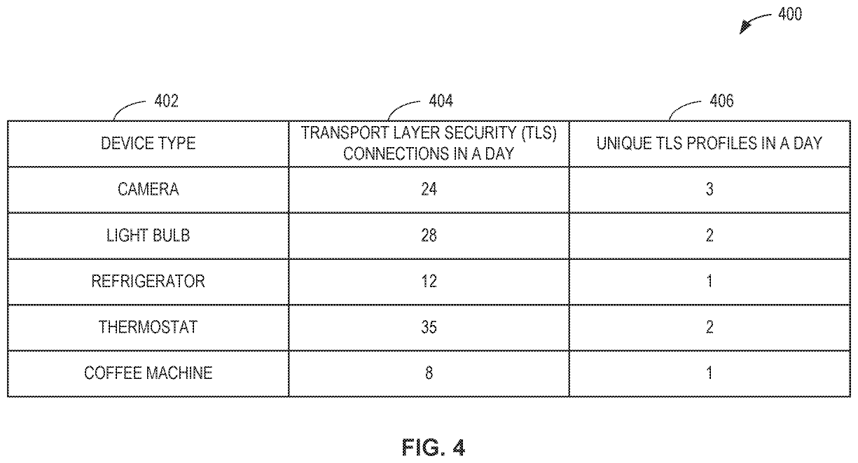

FIG. 4 is a table 400 of example Transport Layer Security (TLS) connection data corresponding to example IoT devices. The table 400 includes a first column 402 identifying example device types, a second column 404 identifying an example number of TLS connections in a day by the corresponding device type, and a third column 406 identifying an example number of distinct or unique TLS profiles in a day corresponding to the device type.

In the illustrated example of FIG. 4, the first column 402 lists example device types of a camera, a light bulb, a refrigerator, a thermostat, and a coffee machine. In some examples, the camera of the table 400 may correspond to the first IoT device 104 of FIG. 1. For example, the first IoT device 104 may initiate 24 TLS connections in a day with three of those TLS connections being unique TLS profiles. In some such examples, the three unique TLS connections may correspond to respective connections to the servers 118, 120, 122 of FIG. 1. In some examples, the light bulb of the table 400 may correspond to the second IoT device 106 of FIG. 1. For example, the second IoT device 106 may initiate 28 TLS connections in a day with two of those TLS connections being unique TLS profiles. In some such examples, the two unique TLS connections may correspond to respective connections to two of the servers 118, 120, 122. In some examples, the refrigerator of the table 400 may correspond to the third IoT device 108 of FIG. 1. For example, the third IoT device 108 may initiate 12 TLS connections in a day with only one of those TLS connections being a unique TLS profile. In some such examples, the unique TLS connection may correspond to a connection to one of the servers 118, 120, 122.

Advantageously, the telemetry controller 102 of FIGS. 1 and/or 2 may reduce (e.g., substantially reduce) the amount of network telemetry data transmitted to the central facility server 110 of FIGS. 1 and/or 3 and the number of times that the network telemetry data needs to be uploaded to the central facility server 110. Advantageously, the telemetry controller 102 may identify the three unique TLS profiles of the camera and transmit the three unique TLS profiles and/or the associated network telemetry data to the central facility server 110 rather than all of the 24 TLS profiles and the associated network telemetry data that may be generated from the 24 TLS daily connections.

FIG. 5 is an example implementation of a TLS client sub-profile 500. In some examples, the TLS client sub-profile 500 may correspond to a TLS client sub-profile based on a TLS flow from the first IoT device 104, the second IoT device 106, or the third IoT device 108 of FIG. 1. For example, the TLS profile generator 230 of FIG. 2 may generate the TLS client sub-profile 500. In some examples, the TLS profile generator 320 of FIG. 3 may generate the TLS client sub-profile 500.

In the illustrated example of FIG. 5, the TLS client sub-profile 500 includes example TLS parameters (e.g., TLS client parameters) 510, 520, 530, 540, 550, 560, 570. The TLS parameters 510, 520, 530, 540, 550, 560, 570 include a first example TLS parameter 510, a second example TLS parameter 520, a third example TLS parameter 530, a fourth example TLS parameter 540, a fifth example TLS parameter 550, a sixth example TLS parameter 560, and a seventh example TLS parameter 570. Additionally or alternatively, the TLS client sub-profile 500 may include any other TLS parameter and/or aspect or portion of a TLS communication.

In this example, the first TLS parameter 510 identifies a network device that obtained a TLS flow. For example, the first TLS parameter 510 may identify the first network device 112, the second network device 114, or the third network device 116 of FIG. 1. In this example, the second TLS parameter 520 may identify a device that generated the TLS flow. For example, the second TLS parameter 520 may identify the first IoT device 104, the second IoT device 106, or the third IoT device 108 of FIG. 1.

In this example, the third TLS parameter 530 may identify the cipher suit that the device may offer. For example, the third TLS parameter 530 may identify a cipher suit that the first IoT device 104, the second IoT device 106, or the third IoT device 108 of FIG. 1 may support. In this example, the fourth TLS parameter 540 may identify a compression method that the device may offer. For example, the fourth TLS parameter 540 may identify a compression method that the first IoT device 104, the second IoT device 106, or the third IoT device 108 of FIG. 1 may support.

In this example, the fifth TLS parameter 550 may identify a TLS extension that the device may offer. For example, the fifth TLS parameter 550 may identify a TLS extension that the first IoT device 104, the second IoT device 106, or the third IoT device 108 of FIG. 1 may support. In this example, the sixth TLS parameter 560 may identify a TLS supported version that the device may offer. For example, the sixth TLS parameter 560 may identify a TLS supported version that the first IoT device 104, the second IoT device 106, or the third IoT device 108 of FIG. 1 may support. In this example, the seventh TLS parameter 570 may identify a TLS signature algorithm that the device may offer. For example, the seventh TLS parameter 570 may identify a TLS signature algorithm that the first IoT device 104, the second IoT device 106, or the third IoT device 108 of FIG. 1 may support.

FIG. 6 is an example implementation of a TLS server sub-profile 600. In some examples, the TLS server sub-profile 600 may correspond to a TLS server sub-profile based on a TLS flow from the first server 118, the second server 120, or the third server 122 of FIG. 1. For example, the TLS profile generator 230 of FIG. 2 may generate the TLS server sub-profile 600. In some examples, the TLS profile generator 320 of FIG. 3 may generate the TLS server sub-profile 600.

In the illustrated example of FIG. 6, the TLS server sub-profile 600 includes example TLS parameters (e.g., TLS server parameters) 610, 620, 630, 640, 650, 660, 670, 680. The TLS parameters 610, 620, 630, 640, 650, 660, 670, 680 include a first example TLS parameter 610, a second example TLS parameter 620, a third example TLS parameter 630, a fourth example TLS parameter 640, a fifth example TLS parameter 650, a sixth example TLS parameter 660, a seventh example TLS parameter 670, and an eighth example TLS parameter 680. Additionally or alternatively, the TLS server sub-profile 600 may include any other TLS parameter and/or aspect or portion of a TLS communication.

In this example, the first TLS parameter 610 identifies a network device that obtained a TLS flow. For example, the first TLS parameter 610 may identify the first network device 112, the second network device 114, or the third network device 116 of FIG. 1. In this example, the second TLS parameter 620 may identify a device that generated the TLS flow. For example, the second TLS parameter 620 may identify the first IoT device 104, the second IoT device 106, or the third IoT device 108 of FIG. 1.

In this example, the third TLS parameter 630 may identify the cipher suit that the server selected. For example, the third TLS parameter 630 may identify a cipher suit that the first server 118, the second server 120, or the third server 122 selected based on what the TLS client supports. In this example, the fourth TLS parameter 640 may identify a compression method that the server selected. For example, the fourth TLS parameter 640 may identify a compression method that the first server 118, the second server 120, or the third server 122 selected based on what the TLS client supports.

In this example, the fifth TLS parameter 650 may identify a hash value of an SHA-1 certificate of the server. For example, the fifth TLS parameter 650 may identify a hash value of an SHA-1 certificate managed by the first server 118, the second server 120, or the third server 122. In this example, the sixth TLS parameter 660 may identify a TLS subject alt name of the server. For example, the sixth TLS parameter 660 may identify a TLS subject alt name of the first server 118, the second server 120, or the third server 122. In this example, the seventh TLS parameter 670 may identify a TLS certificate issuer of the server. For example, the seventh TLS parameter 670 may identify a TLS certificate issuer of the first server 118, the second server 120, or the third server 122. In this example, the eighth TLS parameter 680 may identify a TLS certificate subject of the server. For example, the eighth TLS parameter 680 may identify a TLS certificate subject of the first server 118, the second server 120, or the third server 122.

Flowcharts representative of example hardware logic, machine readable instructions, hardware implemented state machines, and/or any combination thereof for implementing the example telemetry controller 102 of FIGS. 1 and/or 2 and/or the example central facility server 110 of FIGS. 1 and/or 3 are shown in FIGS. 7-11. The machine readable instructions may be one or more executable programs or portion(s) of an executable program for execution by a computer processor and/or processor circuitry, such as the processor 1212 shown in the example processor platform 1200 discussed below in connection with FIG. 12 and/or the processor 1312 shown in the example processor platform 1300 discussed below in connection with FIG. 13. The program may be embodied in software stored on a non-transitory computer readable storage medium such as a CD-ROM, a floppy disk, a hard drive, a DVD, a Blu-ray disk, or a memory associated with the processor 1212 of FIG. 12 and/or the processor 1312 of FIG. 13, but the entire program and/or parts thereof could alternatively be executed by a device other than the processor 1212 of FIG. 12 and/or the processor 1312 of FIG. 13 and/or embodied in firmware or dedicated hardware. Further, although the example program is described with reference to the flowcharts illustrated in FIGS. 7-11, many other methods of implementing the example telemetry controller 102 and/or the example central facility server 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), SQL, Swift, etc.

As mentioned above, the example processes of FIGS. 7-11 may be implemented using executable instructions (e.g., computer and/or machine readable instructions) stored on a non-transitory computer and/or machine readable medium such as an HDD, a flash memory, a read-only memory, a CD, a DVD, a cache, a random-access memory, and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions 700 that may be executed to implement the example telemetry controller 102 of FIGS. 1 and/or 2 to transmit example telemetry data to the example central facility server 110 of FIGS. 1 and/or 3. The machine readable instructions 700 of FIG. 7 begin at block 702, at which the telemetry controller 102 identifies Internet-of-Things (IoT) device(s) in a network. For example, the device identifier 220 (FIG. 2) may identify the first IoT device 104 of FIG. 1 based on identification data (e.g., a device identifier, a type of the first IoT device 104, a manufacturer of the first IoT device 104, etc.) associated with the first IoT device 104.

At block 704, the telemetry controller 102 obtains first Transport Layer Security (TLS) telemetry data associated with the IoT device(s). For example, the communication interface 210 (FIG. 2) may obtain first TLS data including a first TLS client hello message transmitted by the first IoT device 104 to the first server 118 through the telemetry controller 102 and/or, more generally, the first network device 112 of FIG. 1.

At block 706, the telemetry controller 102 obtains second TLS telemetry data associated with server(s) in communication with the IoT device(s). For example, the communication interface 210 may obtain second TLS data including a first TLS server hello message transmitted by the first server 118 to the first IoT device 104, which may be transmitted in response to the first server 118 obtaining the first TLS client hello message from the first IoT device 104. In some such examples, the communication interface 210 may obtain a second TLS server hello message transmitted by the second server 120 to the first IoT device 104, which may be transmitted in response to the second server 120 obtaining a second TLS client hello message from the first IoT device 104.

At block 708, the telemetry controller 102 generates TLS client sub-profile(s) based on the first TLS telemetry data. For example, the TLS profile generator 230 may generate the TLS client sub-profile 500 of FIG. 5 based on the first TLS client hello message.

At block 710, the telemetry controller 102 generates TLS server sub-profile(s) based on the second TLS telemetry data. For example, the TLS profile generator 230 may generate the TLS server sub-profile 600 of FIG. 6 as a first TLS server sub-profile based on the first TLS server hello message. In some such examples, the TLS profile generator 230 may generate a second TLS server sub-profile based on the second TLS server hello message.

At block 712, the telemetry controller 102 generates hash value(s) of at least one of the TLS client sub-profile(s) or the TLS server sub-profile(s). For example, the hash generator 240 (FIG. 2) may generate a first hash value by executing a hash algorithm on the first TLS client sub-profile. In some such examples, the hash generator 240 may generate a second hash value by executing the hash algorithm on the first TLS server sub-profile and/or a third hash value by executing the hash algorithm on the second TLS server sub-profile.

At block 714, the telemetry controller 102 identifies unique TLS profile(s) based on the hash value(s). For example, the TLS profile comparator 250 (FIG. 2) may identify the first TLS client sub-profile, the second TLS server sub-profile, and/or the third TLS server sub-profile as unique TLS profiles (e.g., unique TLS sub-profiles) based on comparisons of the corresponding hash values to the hash values 272 (FIG. 2) of the TLS sub-profile hash datastore 270 (FIG. 2). An example process that may implement block 714 is described below in connection with FIG. 8.

At block 716, the telemetry controller 102 determines whether unique TLS profile(s) are identified. For example, the TLS profile comparator 250 may identify the first TLS client sub-profile as a unique TLS profile. If, at block 716, the telemetry controller 102 determines that no unique TLS profile(s) are identified, then, at block 718, the telemetry controller 102 discards the first TLS telemetry data and the second TLS telemetry data. Advantageously, the telemetry controller 102 may reduce a quantity of network telemetry to be transmitted to the central facility server 110 by identifying whether the network telemetry is associated with a unique TLS profile or a previously identified TLS profile. In response to discarding the first TLS telemetry data and the second TLS telemetry data at block 718, the machine readable instructions 700 of FIG. 7 conclude.

If, at block 716, the telemetry controller 102 determines that one or more unique TLS profiles are identified, control proceeds to block 720 to transmit at least one of the first TLS telemetry data or the second TLS telemetry data to a central facility server. For example, the communication interface 210 may transmit one or more TLS parameters associated with the first TLS client sub-profile to the central facility server 110 in response to identifying the first TLS client sub-profile as a unique TLS profile. In response to transmitting the at least one of the first TLS telemetry data or the second TLS telemetry data to the central facility server at block 720, the machine readable instructions 700 of FIG. 7 conclude.

FIG. 8 is a flowchart representative of example machine readable instructions 800 that may be executed to implement the example telemetry controller 102 of FIGS. 1 and/or 2 to identify unique TLS profile(s) based on hash values. The machine readable instructions 800 of FIG. 8 may be executed to implement block 714 of the machine readable instructions 700 of FIG. 7. The machine readable instructions 800 of FIG. 8 begin at block 802, at which the telemetry controller 102 selects a Transport Layer Security (TLS) client sub-profile to process. For example, the TLS profile comparator 250 (FIG. 2) may select the TLS client sub-profile 500 of FIG. 5 to process. In some such examples, the TLS client sub-profile 500 may be generated based on the TLS parameters 510, 520, 530, 540, 550, 560, 570 of FIG. 5, which may be included in a TLS client hello message transmitted by the first IoT device 104 of FIG. 1.

At block 804, the telemetry controller 102 compares a hash value of the TLS client sub-profile to hash values of known TLS client sub-profiles. For example, the TLS profile comparator 250 may compare a first hash value based on the TLS client sub-profile 500 or portion(s) thereof to the hash values 272 (FIG. 2) of the TLS sub-profile hash datastore 270 (FIG. 2).

At block 806, the telemetry controller 102 determines whether the hash value matches a hash value of a known TLS client sub-profile. For example, the TLS profile comparator 250 may determine that the first hash value matches one of the hash values 272, which is indicative that the first hash value is not based on a unique TLS profile.

If, at block 806, the telemetry controller 102 determines that the hash value does not match a hash value of a known TLS client sub-profile, then, at block 808, the telemetry controller 102 identifies the TLS client sub-profile and associated TLS server sub-profile(s) as unique TLS profile(s). For example, the TLS profile comparator 250 may identify the TLS client sub-profile, the first TLS server sub-profile, the second TLS server sub-profile, etc., as unique TLS profile(s) in response to determining that the first hash value does not match one of the hash values 272. In response to identifying the TLS client sub-profile and associated TLS server sub-profile(s) as unique TLS profile(s) at block 808, the machine readable instructions 800 of FIG. 8 conclude. For example, the machine readable instructions 800 of FIG. 8 may return to block 716 of the machine readable instructions 700 of FIG. 7 to determine whether unique TLS profile(s) is/are identified.

If, at block 806, the telemetry controller 102 determines that the hash value matches a hash value of a known TLS client sub-profile, control proceeds to block 810 to compare hash value(s) of TLS server sub-profile(s) to hash values of known TLS server sub-profiles. For example, the TLS profile comparator 250 may compare a second hash value based on a first TLS server sub-profile, a third hash value based on a second TLS server sub-profile, etc., to the hash values 272. In some such examples, the second hash value and/or the third hash value may be based on the TLS server sub-profile 600 of FIG. 6 or portion(s) thereof.

At block 812, the telemetry controller 102 determines whether hash value(s) match(es) hash value(s) of known TLS server sub-profile(s). For example, the TLS profile comparator 250 may determine whether the second hash value and/or the third hash value matches one(s) of the hash values 272, which may be indicative of the first TLS server sub-profile and/or the second TLS server sub-profile not being unique TLS profile(s).

If, at block 812, the telemetry controller 102 determines that the hash value(s) match(es) hash value(s) of known TLS server sub-profile(s), then, at block 814, the telemetry controller 102 discards telemetry data associated with matching one(s) of TLS client sub-profile and/or TLS server sub-profile(s). For example, the TLS profile comparator 250 may discard first network telemetry data associated with the TLS client sub-profile in response to determining that the first hash value matches one of the hash values 272. In some such examples, the TLS profile comparator 250 may discard second network telemetry data associated with the first TLS server sub-profile in response to determining that the second hash value matches one of the hash values 272. In some such examples, the TLS profile comparator 250 may discard third network telemetry data associated with the second TLS server sub-profile in response to determining that the third hash value matches one of the hash values 272.

In response to discarding telemetry data associated with matching one(s) of the TLS client sub-profile and/or the TLS server sub-profile(s) at block 814, the machine readable instructions 800 of FIG. 8 conclude. For example, the machine readable instructions 800 of FIG. 8 may return to block 716 of the machine readable instructions 700 of FIG. 7 to determine whether unique TLS profile(s) is/are identified.

If, at block 812, the telemetry controller 102 determines that the hash value(s) do not match hash value(s) of known TLS server sub-profile(s), control proceeds to block 816 to identify matching TLS server sub-profile(s) as unique TLS server sub-profile(s). For example, the TLS profile comparator 250 may identify the first TLS server sub-profile as a unique TLS profile in response to determining that the second hash value does not match one of the hash values 272. In some such examples, the TLS profile comparator 250 may identify the second TLS server sub-profile as a unique TLS profile in response to determining that the third hash value does not match one of the hash values 272.

In response to identifying matching TLS server sub-profile(s) as unique TLS server sub-profile(s) at block 816, the machine readable instructions 800 of FIG. 8 conclude. For example, the machine readable instructions 800 of FIG. 8 may return to block 716 of the machine readable instructions 700 of FIG. 7 to determine whether unique TLS profile(s) is/are identified.

FIG. 9 is a flowchart representative of example machine readable instructions 900 that may be executed to implement the example central facility server 110 of FIGS. 1 and/or 3 to distribute example firewall rules and/or example machine-learning model(s) to the example telemetry controller 102 of FIGS. 1 and/or 2. The machine readable instructions 900 of FIG. 9 begin at block 902, at which the central facility server 110 identifies Transport Layer Security (TLS) profile(s) based on communications from network device(s). For example, the TLS profile comparator 340 (FIG. 3) may identify TLS profile(s) based on communications obtained by the communication interface 310 (FIG. 3) from the first network device 112 of FIG. 1. An example process that may be executed to implement block 902 is described below in connection with FIG. 10.

At block 904, the central facility server 110 compares TLS profile(s) to known TLS profiles. For example, the hash generator 330 (FIG. 3) may generate a first hash value based on a TLS client sub-profile associated with the first IoT device 104 of FIG. 1. In some such examples, the hash generator 330 may generate a second hash value based on a first TLS server sub-profile associated with the first server 118 of FIG. 1. In some such examples, the hash generator 330 may generate a third hash value based on a second TLS server sub-profile associated with the second server 120 of FIG. 1. In some such examples, the TLS profile comparator 340 may compare the first hash value, the second hash value, and the third hash value to the hash values 372 of FIG. 3.

At block 906, the central facility server 110 discards network telemetry data associated with matching TLS profile(s). For example, the TLS profile comparator 340 may discard TLS parameter(s) associated with the TLS client sub-profile in response to determining that the first hash value matches one of the hash values 372.

At block 908, the central facility server 110 stores non-matching TLS profile(s) as unique TLS profile(s). For example, the TLS profile comparator 340 may store the first hash value in the TLS sub-profile hash datastore 370 in response to determining that the first hash value does not match one of the hash values 372.

At block 910, the central facility server 110 executes anomaly detection on non-matching TLS profile(s). For example, the security controller 350 (FIG. 3) may execute one or more anomaly detection algorithms on the TLS client sub-profile, the first TLS server sub-profile, and/or the second TLS server sub-profile. In some such examples, the security controller 350 may detect whether the first TLS server sub-profile, and/or the second TLS server sub-profile are indicative of abnormal computing or networking behavior based on output(s) from the anomaly detection algorithms.

At block 912, the central facility server 110 labels non-matching TLS profile(s) based on the anomaly detection. For example, the security controller 350 may label the TLS client sub-profile as a benign TLS profile, which is indicative of being associated with a benign TLS flow. In some such examples, the TLS client sub-profile may be labeled as a benign TLS flow in response to the security controller 350 detecting that the TLS client sub-profile is not associated with abnormal behavior. In some examples, the security controller 350 may label the first TLS server sub-profile as a malicious TLS profile, which is indicative of being associated with a malicious TLS flow. In some such examples, the first TLS server sub-profile may be labeled as a malicious TLS flow in response to the security controller 350 detecting that the first TLS server sub-profile is associated with abnormal behavior.

At block 914, the central facility server 110 generates firewall rule(s) based on the label(s). For example, the security controller 350 may generate a first firewall rule to allow TLS flows from a device that has the TLS client sub-profile. In some such examples, the security controller 350 may generate a second firewall rule to block TLS flows from a server that has the first TLS server sub-profile.

At block 916, the central facility server 110 trains machine-learning model(s) based on at least one of the unique TLS profile(s) or the firewall rule(s). For example, the security controller 350 may train the machine-learning model(s) 382 based on at least one of the first firewall rule, the second firewall rule, the TLS client sub-profile (or TLS parameter(s) thereof), the first TLS server sub-profile (or TLS parameter(s) thereof), or the second TLS server sub-profile (or TLS parameter(s) thereof).

At block 918, the central facility server 110 distributes at least one of the firewall rule(s) or the machine-learning model(s) to the network device(s). For example, the application distributor 360 (FIG. 3) may distribute an application, firmware, software, an executable, etc., based on at least one of the first firewall rule, the second firewall rule, or one(s) of the machine-learning model(s) 382 to one(s) of the network devices 112, 114, 116 of FIG. 1. In response to distributing the at least one of the firewall rule(s) or the machine-learning model(s) to the network device(s) at block 918, the machine readable instructions of FIG. 9 conclude.

FIG. 10 is a flowchart representative of example machine readable instructions 1000 that may be executed to implement the example central facility server 110 of FIGS. 1 and/or 3 to identify TLS profile(s) based on communications from the example telemetry controller 102 of FIGS. 1 and/or 2. The machine readable instructions 1000 of FIG. 10 may be executed to implement block 902 of the machine readable instructions 900 of FIG. 9. The machine readable instructions 1000 of FIG. 10 begin at block 1002, at which the central facility server 110 determines whether communications include TLS client telemetry data and TLS server telemetry data. For example, the communication interface 310 (FIG. 3) may determine that one or more data communications from the first network device 112 of FIG. 1 include TLS client telemetry data including one or more TLS parameters associated with a TLS client hello message and/or TLS server telemetry data including one or more TLS parameters associated with a TLS server hello message.

If, at block 1002, the central facility server 110 determines that the communications do not include TLS client telemetry data and TLS server telemetry data, control proceeds to block 1008 to determine whether the communications include TLS server telemetry data and hash value(s) based on a TLS client sub-profile. If, at block 1002, the central facility server 110 determines that the communications include TLS client telemetry data and TLS server telemetry data, then, at block 1004, the central facility server 110 generates a TLS client sub-profile and TLS server sub-profile(s) based on the TLS client and TLS server telemetry data. For example, the TLS profile generator 320 (FIG. 3) may generate a TLS client sub-profile based on TLS client telemetry data associated with the first IoT device 104, a first TLS server sub-profile based on first TLS server telemetry data associated with the first server 118 of FIG. 1, a second TLS server sub-profile based on second TLS server telemetry data associated with the second server 120 of FIG. 1, etc.

At block 1006, the central facility server 110 compares TLS sub-profile(s) to known TLS sub-profile(s). For example, the TLS profile comparator 340 (FIG. 3) may compare a first hash value based on the TLS client sub-profile, a second hash value based on the first TLS server sub-profile, a third hash value based on the second TLS server sub-profile, etc., to the hash values 372 (FIG. 3) of the TLS sub-profile hash datastore 370 (FIG. 3).

At block 1008, the central facility server 110 determines whether the communications include TLS server telemetry data and hash value(s) based on a TLS client sub-profile. For example, the communication interface 310 may determine that the one or more data communications from the first network device 112 of FIG. 1 do not include TLS client telemetry data and include TLS server telemetry data and a hash value based on a TLS client sub-profile. In some such examples, the communication interface 310 may determine that the lack of TLS client telemetry data in the communications indicate that network telemetry data associated with the hash value has already been transmitted to the central facility server 110.

If, at block 1008, the central facility server 110 determines that the communications do not include TLS server telemetry data and hash value(s) based on the TLS client sub-profile, control proceeds to block 1014 to determine whether matches are identified based on the comparisons. If, at block 1008, the central facility server 110 determines that the communications include TLS server telemetry data and hash value(s) based on the TLS client sub-profile, then, at block 1010, the central facility server 110 generates TLS server sub-profile(s) based on the TLS server telemetry data. For example, the TLS profile generator 320 may generate the first TLS server sub-profile based on the first TLS server telemetry data associated with the first server 118 of FIG. 1, the second TLS server sub-profile based on the second TLS server telemetry data associated with the second server 120 of FIG. 1, etc.

At block 1012, the central facility server 110 compares TLS server sub-profile(s) to known TLS server sub-profile(s). For example, the TLS profile comparator 340 may compare the second hash value based on the first TLS server sub-profile, the third hash value based on the second TLS server sub-profile, etc., to the hash values 372 of the TLS sub-profile hash datastore 370.

At block 1014, the central facility server 110 determines whether matches have been identified based on the comparisons. For example, the TLS profile comparator 340 may determine that the first hash value, the second hash value, and/or the third hash value match one(s) of the hash values 372.

If, at block 1014, the central facility server 110 determines that a match has been identified based on the comparisons, then, at block 1016, the central facility server 110 discards matching TLS server sub-profile(s). For example, the TLS profile comparator 340 may discard the TLS client telemetry data in response to determining that the first hash value matches on one of the hash values 372. In some examples, the TLS profile comparator 340 may discard the first TLS server telemetry data in response to determining that the second hash value matches on one of the hash values 372. In some examples, the TLS profile comparator 340 may discard the second TLS server telemetry data in response to determining that the third hash value matches on one of the hash values 372.

If, at block 1014, the central facility server 110 determines that a match has not been identified based on the comparisons, control proceeds to block 1018 to identify non-matching TLS profile(s) as unique TLS profile(s). For example, the TLS profile comparator 340 may identify the TLS client sub-profile as a unique TLS profile in response to determining that the first hash value does not match one of the hash values 372. In some examples, the TLS profile comparator 340 may identify the first TLS server sub-profile and/or the second TLS server sub-profile as unique TLS profile(s) in response to determining that a respective one of the second hash value and/or the third hash value does not match one of the hash values 372.

At block 1020, the central facility server 110 stores association(s) of TLS client sub-profile and corresponding TLS server sub-profile(s). For example, the TLS profile comparator 340 may store the TLS client sub-profile, the TLS client telemetry data, and/or the first hash value, and/or association(s) thereof, in the TLS sub-profile hash datastore 370 in response to identifying the TLS client sub-profile as a unique TLS profile. In some examples, the TLS profile comparator 340 may store the first TLS server sub-profile, the first TLS server telemetry data, and/or the second hash value, and/or association(s) thereof, in the TLS sub-profile hash datastore 370 in response to identifying the first TLS server sub-profile as a unique TLS profile. In some examples, the TLS profile comparator 340 may store the second TLS server sub-profile, the second TLS server telemetry data, and/or the third hash value, and/or association(s) thereof, in the TLS sub-profile hash datastore 370 in response to identifying the second TLS server sub-profile as a unique TLS profile. In response to storing the association(s) of the TLS client sub-profile and the corresponding TLS server sub-profile(s) at block 1020, the machine readable instructions 1000 of FIG. 10 conclude.

FIG. 11 is a flowchart representative of example machine readable instructions 1100 that may be executed to implement the example telemetry controller 102 of FIGS. 1 and/or 2 and/or the example central facility server 110 of FIGS. 1 and/or 3 to execute mitigation measures based on detected malicious behavior. The machine readable instructions 1100 of FIG. 11 begin at block 1102, at which the telemetry controller 102 identifies type(s) of device(s) in a network. For example, the device identifier 220 (FIG. 2) may implement a device discovery operation. In some such examples, the device identifier 220 may broadcast one or more discovery packets to devices within range of the telemetry controller 102 in the network environment 126. In some such examples, the communication interface 210 (FIG. 2) may obtain response packets (e.g., discovery response packets) from one(s) of the IoT devices 104, 106, 108. For example, the device identifier 220 may identify a type of the one(s) of the IoT devices 104, 106, 108, a manufacturer and/or vendor, etc., of the one(s) of the IoT devices 104, 106, 108 based on device identification information in the response packets.

At block 1104, the central facility server 110 distributes firewall rules and machine-learning model(s) to a network device based on the device type(s). For example, the communication interface 310 (FIG. 3) may receive data indicating the device type(s) of the one(s) of the IoT devices 104, 106, 108 from the telemetry controller 102 of the first network device 112. In some such examples, the security controller 350 (FIG. 3) and/or the application distributor 360 (FIG. 3) may identify one or more firewall rules that correspond to the device type(s). For example, the security controller 350 and/or the application distributor 360 may identify a first firewall rule indicative of allowing TLS flows from a first device type that is associated with, or, in some examples, matches one of the received device type(s), a second firewall rule indicative of blocking TLS flows from a second device type that is associated with, or, in some examples, matches one of the received device type(s), etc.

In some examples, the security controller 350 and/or the application distributor 360 may identify one(s) of the machine-learning model(s) 382 (FIG. 3) that correspond to the device type(s). For example, the security controller 350 and/or the application distributor 360 may identify a first one of the machine-learning model(s) 382 that is based on, trained on, etc., TLS parameters associated with the first device type, the second device type, etc. In some such examples, the application distributor 360 may generate one or more executables that, when executed by the telemetry controller 102, may implement the one or more identified firewall rules, the one or more identified one(s) of the machine-learning model(s) 382, etc., and/or a combination thereof. In some such examples, the application distributor 360 may transmit, deliver, and/or otherwise distribute the one or more executables to the telemetry controller 102 of the first network device 112 via the network 124 of FIG. 1.

At block 1106, the telemetry controller 102 receives a data communication including Transport Layer Security (TLS) telemetry data from the device(s) and server(s). For example, the communication interface 210 may receive a TLS client hello message transmitted from the first IoT device 104 to the first server 118. In some such examples, the communication interface 210 may receive a TLS server hello message transmitted from the first server 118 to the first IoT device 104. In some such examples, the communication interface 210 may identify one or more first TLS parameters included in the TLS client hello message that correspond to the first IoT device 104 operating as a TLS client. In some such examples, the communication interface 210 may identify one or more second TLS parameters included in the TLS server hello message that correspond to the first server 118 operating as a TLS server. In some such examples, the communication interface 210 may store the TLS client hello message, the TLS server hello message, the one or more first TLS parameters, and/or the one or more second TLS parameters in the network telemetry datastore 290 (FIG. 2) as network telemetry (e.g., network telemetry data, TLS data, TLS telemetry, TLS network telemetry, TLS network telemetry data, etc.).

At block 1108, the telemetry controller 102 generates a TLS client sub-profile and TLS server sub-profile(s) based on the TLS telemetry data. For example, the TLS profile generator 230 (FIG. 2) may generate a TLS profile including a TLS client sub-profile that corresponds to the first IoT device 104 operating as a TLS client and a TLS server sub-profile that corresponds to the first server 118 operating as a TLS server. In some such examples, the TLS profile generator 230 may generate the TLS client sub-profile 500 of FIG. 5 based on the one or more first TLS parameters. In some such examples, the TLS profile generator 230 may generate the TLS server sub-profile 600 of FIG. 6 based on the one or more second TLS parameters.

At block 1110, the telemetry controller 102 compares the TLS client sub-profile and the TLS server sub-profile(s) to known TLS sub-profiles. For example, the hash generator 240 (FIG. 2) may generate a first hash value based on the TLS client sub-profile 500 and a second hash value based on the TLS server sub-profile 600. In some such examples, the TLS profile comparator 250 (FIG. 2) may compare the first hash value and/or the second hash value to one(s) of the hash value(s) 272 (FIG. 2).

At block 1112, the telemetry controller 102 determines whether a match is identified. For example, the TLS profile comparator 250 may identify a match in response to a determination that the first hash value and/or the second hash value match one(s) of the hash value(s) 272.

If, at block 1112, the telemetry controller 102 determines that a match is identified, control proceeds to block 1116 to compare a data communication to firewall rules. If, at block 1112, the telemetry controller 102 determines that a match is not identified, then, at block 1114, the telemetry controller 102 transmits unique TLS sub-profile(s) to a central facility server. For example, in response to determining that the first hash value does not match one of the hash value(s) 272, the TLS profile comparator 250 may identify the TLS client sub-profile that corresponds to the first hash value as a unique TLS profile. In some such examples, the TLS profile comparator 250 may direct, instruct, and/or otherwise invoke the communication interface 210 to transmit the TLS client sub-profile, the one or more first TLS parameters associated with the TLS client sub-profile, device identification information corresponding to the first IoT device 104, etc., and/or a combination thereof, to the central facility server 110.

In some examples, in response to determining that the second hash value does not match one of the hash value(s) 272, the TLS profile comparator 250 may identify the TLS server sub-profile that corresponds to the second hash value as a unique TLS profile. In some such examples, the TLS profile comparator 250 may direct, instruct, and/or otherwise invoke the communication interface 210 to transmit the TLS server sub-profile, the one or more second TLS parameters associated with the TLS server sub-profile, etc., and/or a combination thereof, to the central facility server 110.

In some examples, in response to determining that the first hash value matches one of the hash value(s) 272, the TLS profile comparator 250 may identify the TLS client sub-profile that corresponds to the first hash value as a non-unique TLS profile. In some such examples, the TLS profile comparator 250 may not transmit the TLS client sub-profile, the one or more first TLS parameters associated with the TLS client sub-profile, the device identification information corresponding to the first IoT device 104, etc., and/or a combination thereof, to the central facility server 110. Advantageously, in some such examples, the TLS profile comparator 250, and/or, more generally, the telemetry controller 102, may reduce a quantity of network telemetry data to be transmitted to the central facility server 110 in response to identifying non-unique TLS client sub-profiles, and/or, more generally, non-unique TLS profiles.

In some examples, in response to determining that the second hash value matches one of the hash value(s) 272, the TLS profile comparator 250 may identify the TLS server sub-profile that corresponds to the second hash value as a non-unique TLS profile. In some such examples, the TLS profile comparator 250 may not transmit the TLS server sub-profile, the one or more second TLS parameters associated with the TLS server sub-profile, etc., and/or a combination thereof, to the central facility server 110. Advantageously, in some such examples, the TLS profile comparator 250, and/or, more generally, the telemetry controller 102, may reduce a quantity of network telemetry data to be transmitted to the central facility server 110 in response to identifying non-unique TLS server sub-profiles, and/or, more generally, non-unique TLS profiles.

At block 1116, the telemetry controller 102 compares a data communication to firewall rules. For example, the security handler 260 (FIG. 2) may compare one or more TLS parameters of a TLS flow transmitted from the first IoT device 104 to the first server 118 to the firewall rules received from the central facility server 110. In some such examples, the security handler 260 may identify malicious behavior based on the comparison(s). For example, the security handler 260 may determine that the one or more TLS parameters, and/or, more generally, the TLS flow, may violate a first one of the firewall rules. In some examples, the security handler 260 may determine that the one or more TLS parameters, and/or, more generally, the TLS flow, do(es) not violate the first one of the firewall rules and the security handler 260 may allow and/or otherwise not prevent the transmission of the TLS flow.

At block 1118, the telemetry controller 102 executes the machine-learning model(s) with the data communication or portion(s) thereof as input(s). For example, the security handler 260 may execute the machine-learning model(s) 282 obtained from the central facility server 110 and use the one or more TLS parameters, and/or, more generally, the TLS flow, as input(s) (e.g., machine-learning model input(s)) to the machine-learning model(s) 282. For example, the security handler 260 may execute the machine-learning model(s) 282 to generate a first output, which may include a malicious label that indicates that the one or more TLS parameters, and/or, more generally, the TLS flow, are associated with and/or otherwise implement malicious computing behavior. In some examples, the security handler 260 may execute the machine-learning model(s) 282 to generate a second output, which may include a benign, legitimate, or trustworthy label that indicates that the one or more TLS parameters, and/or, more generally, the TLS flow, are not associated with and/or otherwise implement malicious computing behavior.

At block 1120, the telemetry controller 102 determines whether malicious behavior associated with the data communication is detected. For example, in response to the firewall rule comparison(s) and/or the machine-learning model execution(s), the security handler 260 may not detect malicious behavior associated with the data communication from the first IoT device 104. In some examples, in response to the firewall rule comparison(s) and/or the machine-learning model execution(s), the security handler 260 may detect malicious behavior associated with the data communication from the first IoT device 104.

If, at block 1120, the telemetry controller 102 determines that malicious behavior is not associated with the data communication is detected, the machine readable instructions 1100 of FIG. 11 conclude. If, at block 1120, the telemetry controller 102 determines that malicious behavior is associated with the data communication is detected, then, at block 1122, the telemetry controller 102 executes mitigation measure(s) based on the malicious behavior detection. For example, the security handler 260 may discard or block the TLS flow in response to a detection of malicious computing behavior to protect the first network device 112, the second IoT device 106, the third IoT device 108, and/or, more generally, the network environment 126 of FIG. 1, from being compromised by a malicious actor or entity. In some examples, the security handler 260 may store the TLS flow in a TEE, a sandbox, or other isolated execution environment in response to a detection of malicious computing behavior. In response to executing the mitigation measure(s) based on the malicious behavior at block 1122, the machine readable instructions 1100 of FIG. 11 conclude.

FIG. 12 is a block diagram of an example processor platform 1200 structured to execute the instructions of FIGS. 7, 8, and/or 11 to implement the example telemetry controller 102 of FIGS. 1 and/or 2. The processor platform 1200 can be, for example, an access point, a gateway, a modem, a router, a server, a personal computer, a workstation, a self-learning machine (e.g., a neural network), an Internet appliance, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 1212 implements the example device identifier 220, the example TLS profile generator 230, the example hash generator 240, the example TLS profile comparator 250, and the example security handler 260 of FIG. 2.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. In this example, the bus 1218 may implement the bus 295 of FIG. 2. The volatile memory 1214 may be implemented by SDRAM, DRAM, RDRAM®, and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), a Bluetooth® interface, a near field communication (NFC) interface, and/or a PCI express interface.

In the illustrated example, one or more input devices 1222 are connected to the interface circuit 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display (LCD), an in-place switching (IPS) display, a touchscreen, etc.), a tactile output device, a printer, and/or speaker. The interface circuit 1220 of the illustrated example, thus, typically includes a graphics driver card, a graphics driver chip, and/or a graphics driver processor.

The interface circuit 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1226. The communication can be via, for example, an Ethernet connection, a DSL connection, a telephone line connection, a coaxial cable system, a satellite system, a line-of-site wireless system, a cellular telephone system, etc. In this example, the interface circuit 1220 implements the example communication interface 210 of FIG. 2.

The processor platform 1200 of the illustrated example also includes one or more mass storage devices 1228 for storing software and/or data. Examples of such mass storage devices 1228 include floppy disk drives, HDDs, CD drives, Blu-ray disk drives, redundant array of independent disks (RAID) systems, and DVD drives. In this example, the one or more mass storage devices 1228 implement the example TLS sub-profile hash datastore 270 of FIG. 2, which includes the example hash value(s) 272 of FIG. 2. In this example, the one or more mass storage devices 1228 implement the example machine-learning model datastore 280 of FIG. 2, which includes the example ML model(s) 282 of FIG. 2. In this example, the one or more mass storage devices 1228 implement the example network telemetry datastore 290 of FIG. 2.

The machine executable instructions 1232 of FIGS. 7, 8, and/or 11 may be stored in the mass storage device 1228, in the volatile memory 1214, in the non-volatile memory 1216, and/or on a removable non-transitory computer readable storage medium such as a CD or DVD.

The processor platform 1200 of the illustrated example of FIG. 12 includes an example neural network processor 1240. In this example, the neural network processor 1240 is in communication with different hardware of the processor platform 1200, such as the volatile memory 1214, the non-volatile memory 1216, etc., via the bus 1218. In this example, the neural network processor 1240 may be implemented by one or more integrated circuits, logic circuits, microprocessors, GPUs, DSPs, or controllers from any desired family or manufacturer that can be used to execute an AI model, such as a neural network, which may be implemented by the ML model(s) 282. In some examples, one or more of the example device identifier 220, the example TLS profile generator 230, the example hash generator 240, the example TLS profile comparator 250, and/or the example security handler 260 may be implemented in or with the neural network processor 1240 instead of or in addition to the processor 1212.

FIG. 13 is a block diagram of an example processor platform 1300 structured to execute the instructions of FIGS. 9, 10, and/or 11 to implement the example central facility server 110 of FIGS. 1 and/or 3. The processor platform 1300 can be, for example, a server, a personal computer, a workstation, a self-learning machine (e.g., a neural network), or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 1312 implements the example TLS profile generator 320, the example hash generator 330, the example TLS profile comparator 340, the example security controller 350, and the example application distributor 360 of FIG. 3.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. In this example, the bus 1318 may implement the bus 390 of FIG. 3. The volatile memory 1314 may be implemented by SDRAM, DRAM, RDRAM®, and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a USB, a Bluetooth® interface, an NFC interface, and/or a PCI express interface.

In the illustrated example, one or more input devices 1322 are connected to the interface circuit 1320. The input device(s) 1322 permit(s) a user to enter data and/or commands into the processor 1312. The input device(s) can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuit 1320 of the illustrated example. The output devices 1324 can be implemented, for example, by display devices (e.g., an LED, an OLED, an LCD, an IPS display, a touchscreen, etc.), a tactile output device, a printer, and/or speaker. The interface circuit 1320 of the illustrated example, thus, typically includes a graphics driver card, a graphics driver chip, and/or a graphics driver processor.

The interface circuit 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1326. The communication can be via, for example, an Ethernet connection, a DSL connection, a telephone line connection, a coaxial cable system, a satellite system, a line-of-site wireless system, a cellular telephone system, etc. In this example, the interface circuit 1320 implements the example communication interface 310 of FIG. 2.

The processor platform 1300 of the illustrated example also includes one or more mass storage devices 1328 for storing software and/or data. Examples of such mass storage devices 1328 include floppy disk drives, HDDs, CD drives, Blu-ray disk drives, RAID systems, and DVD drives. In this example, the one or more mass storage devices 1328 implement the example TLS sub-profile hash datastore 370 of FIG. 3, which includes the example hash value(s) 372 of FIG. 3. In this example, the one or more mass storage devices 1328 implement the example machine-learning model datastore 380 of FIG. 3, which includes the example ML model(s) 382 of FIG. 3.

The machine executable instructions 1332 of FIGS. 9, 10, and/or 11 may be stored in the mass storage device 1328, in the volatile memory 1314, in the non-volatile memory 1316, and/or on a removable non-transitory computer readable storage medium such as a CD or DVD.

The processor platform 1300 of the illustrated example of FIG. 13 includes an example neural network processor 1340. In this example, the neural network processor 1340 is in communication with different hardware of the processor platform 1300, such as the volatile memory 1314, the non-volatile memory 1316, etc., via the bus 1318. In this example, the neural network processor 1340 may be implemented by one or more integrated circuits, logic circuits, microprocessors, GPUs, DSPs, or controllers from any desired family or manufacturer that can be used to execute an AI model, such as a neural network, which may be implemented by the ML model(s) 382. In some examples, one or more of the example TLS profile generator 320, the example hash generator 330, the example TLS profile comparator 340, the example security controller 350, and/or the example application distributor 360 may be implemented in or with the neural network processor 1340 instead of or in addition to the processor 1312.

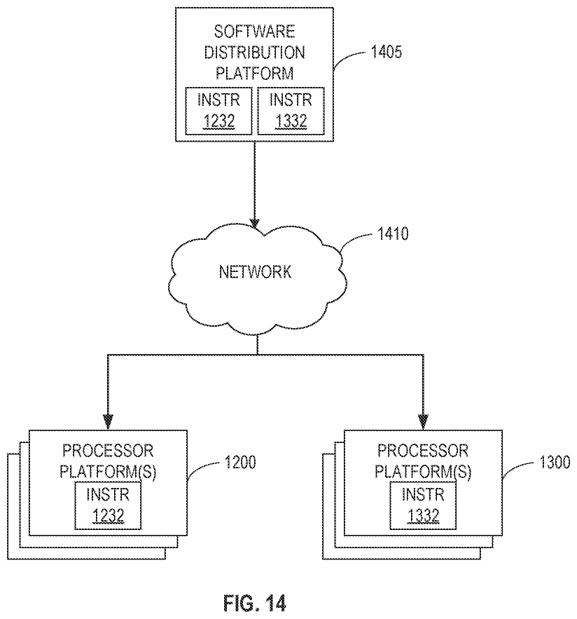

A block diagram illustrating an example software distribution platform 1405 to distribute software such as the example machine readable instructions 1232 of FIG. 13 and/or the machine readable instructions 1332 of FIG. 13 to third parties is illustrated in FIG. 14. For example, FIG. 14 may illustrate an example illustration of distributing software (e.g., software corresponding to the example machine readable instructions of FIGS. 7, 8, 9, 10, and/or 11) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The example software distribution platform 1405 may be implemented by any computer server, data facility, cloud service, etc., capable of storing and transmitting software to other computing devices. For example, the software distribution platform 1405 may be implemented by the central facility server 110 of FIGS. 1 and/or 3. The third parties may be customers of the entity owning and/or operating the software distribution platform 1405. For example, the entity that owns and/or operates the software distribution platform may be a developer, a seller, and/or a licensor of software such as the example machine readable instructions 1232 of FIG. 12 and/or the machine readable instructions 1332 of FIG. 13. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1232, 1332, which may correspond to the example machine readable instructions 700, 800, 900, 1000, 1100 of FIGS. 7, 8, 9, 10, and/or 11 as described above. The one or more servers of the example software distribution platform 1405 are in communication with a network 1410, which may correspond to any one or more of the Internet and/or any of the example networks 124, 1226, 1326 described above. In some examples, the one or more servers are responsive to requests to transmit the software to a requesting party as part of a commercial transaction. Payment for the delivery, sale, and/or license of the software may be handled by the one or more servers of the software distribution platform 1405 and/or via a third party payment entity. The servers enable purchasers and/or licensors to download the machine readable instructions 1232, 1332 from the software distribution platform 1405. For example, the software, which may correspond to the example machine readable instructions 700, 800, 900, 1000, 1100 of FIGS. 7, 8, 9, 10, and/or 11, may be downloaded to the example processor platform 1200 of FIG. 12 and/or the example processor platform 1300 of FIG. 13, which is/are to execute the machine readable instructions 1232, 1332 to implement the example telemetry controller 102 of FIGS. 1 and/or 2 and/or the example central facility server 110 of FIGS. 1 and/or 3. In some examples, one or more servers of the software distribution platform 1405 periodically offer, transmit, and/or force updates to the software (e.g., the example machine readable instructions 1232 of FIG. 12 and/or the example machine readable instructions 1332 of FIG. 13) to ensure improvements, patches, updates, etc., are distributed and applied to the software at the end user devices.

From the foregoing, it will be appreciated that example systems, methods, apparatus, and articles of manufacture have been disclosed that optimize and/or otherwise improve telemetry collection and processing of TLS parameters. Example systems, methods, apparatus, and articles of manufacture disclosed herein generate TLS profiles for enterprise devices, IoT devices, etc., in a network environment. Example systems, methods, apparatus, and articles of manufacture utilize such generated TLS profiles to limit the amount of network telemetry being sent out of network devices, such as gateways, routers, etc. Advantageously, example systems, methods, apparatus, and articles of manufacture disclosed herein reduce the amount of compute and/or memory hardware resources of the network devices to store and/or transmit network telemetry by storing and/or transmitting network telemetry associated with unique TLS profiles and/or discarding network telemetry associated with non-unique TLS profiles.

Example systems, methods, apparatus, and articles of manufacture disclosed herein dynamically provision TLS profiles to network devices based on type(s) of device(s) connected in a network environment. Advantageously, example systems, methods, apparatus, and articles of manufacture reduce the amount of compute and/or memory hardware resources of the network devices to store and/or execute a firewall, a machine-learning model, etc., by executing a firewall, a machine-learning model, etc., that is/are tailored to and/or otherwise correspond(s) to the type(s) of device(s) in the network environment rather than store and/or execute generic, redundant, etc., firewalls, machine-learning models, etc., that may not be as effective or needed in general. Example systems, methods, apparatus, and articles of manufacture disclosed herein generate labels for TLS flows for training of machine-learning models based on collected TLS profiles and/or network telemetry associated with the collected TLS profiles to improve network security of network environments and/or to reduce the probability of network devices becoming compromised. The disclosed systems, methods, apparatus, and articles of manufacture are accordingly directed to one or more improvement(s) in the functioning of a computer.

Example methods, apparatus, systems, and articles of manufacture to optimize and/or otherwise improve telemetry collection and processing of Transport Layer Security Parameters are disclosed herein. Further examples and combinations thereof include the following:

Example 1 includes an apparatus comprising at least one memory, instructions, and at least one processor to execute the instructions to generate a Transport Layer Security (TLS) client sub-profile based on first telemetry data associated with a client device, the TLS client sub-profile including a first TLS parameter associated with the client device, generate a TLS server sub-profile based on second telemetry data associated with a first server, the TLS server sub-profile including a second TLS parameter associated with the first server, generate a hash value based on at least one of the TLS client sub-profile or the TLS server sub-profile, compare the hash value to a plurality of hash values corresponding to known TLS profiles, and in response to identifying the at least one of the TLS client sub-profile or the TLS server sub-profile as a unique TLS profile based on the comparisons, transmit the at least one of the first telemetry data or the second telemetry data to a second server.

Example 2 includes the apparatus of example 1, wherein the first telemetry data is generated in response to the client device transmitting a first data communication to the first server, and the second telemetry data is generated in response to the first server transmitting a second data communication to the client device.

Example 3 includes the apparatus of example 1, wherein the hash value is a first hash value based on the TLS client sub-profile, and the at least one processor is to, in response to the first hash value not matching a second hash value of the plurality of the hash values, transmit the first telemetry data and the second telemetry data to the second server, the TLS client sub-profile identified as the unique TLS profile based on the first hash value not matching the second hash value.

Example 4 includes the apparatus of example 1, wherein the hash value is a first hash value based on the TLS client sub-profile, and the at least one processor is to in response to the first hash value matching a second hash value of the plurality of the hash values, generate a third hash value based on the TLS server sub-profile, the second hash value corresponding to a known TLS client sub-profile, and in response to the third hash value not matching a fourth hash value of the plurality of the hash values, transmit the first hash value and the second telemetry data to the second server, the TLS server sub-profile identified as the unique TLS profile based on the third hash value not matching the fourth hash value, the fourth hash value corresponding to a known TLS server sub-profile.

Example 5 includes the apparatus of example 1, wherein the TLS server sub-profile is a first TLS server sub-profile, and the at least one processor is to generate a second TLS server sub-profile based on third telemetry data associated with a third server, the second TLS server sub-profile including the second TLS parameter or a third TLS parameter associated with the third server, the third telemetry data is generated in response to the third server transmitting a data communication to the client device.

Example 6 includes the apparatus of example 5, wherein the hash value is a first hash value, and the at least one processor is to generate a second hash value based on the second TLS server sub-profile, and in response to the second hash value not matching a third hash value of the plurality of the hash values, transmit the third telemetry data to the second server, the third hash value corresponding to a known TLS server sub-profile.

Example 7 includes the apparatus of example 1, wherein the client device is a first client device with a first type, the TLS client sub-profile is a first TLS client sub-profile, the TLS server sub-profile is a first TLS server sub-profile, and the at least one processor is to identify a second type of a second client device in a network including the first client device, and receive at least one of a second TLS client sub-profile or a second TLS server sub-profile from the second server, the second TLS client sub-profile and the second TLS server sub-profile corresponding to the second type.

Example 8 includes an apparatus comprising first means for generating to generate a Transport Layer Security (TLS) client sub-profile based on first telemetry data associated with a client device, the TLS client sub-profile including a first TLS parameter associated with the client device, and generate a TLS server sub-profile based on second telemetry data associated with a first server, the TLS server sub-profile including a second TLS parameter associated with the first server, second means for generating a hash value based on at least one of the TLS client sub-profile or the TLS server sub-profile, means for comparing the hash value to a plurality of hash values corresponding to known TLS profiles, and means for transmitting the at least one of the first telemetry data or the second telemetry data to a second server in response to identifying the at least one of the TLS client sub-profile or the TLS server sub-profile as a unique TLS profile based on the comparisons.

Example 9 includes the apparatus of example 8, wherein the first telemetry data is generated in response to the client device transmitting a first data communication to the first server, and the second telemetry data is generated in response to the first server transmitting a second data communication to the client device.

Example 10 includes the apparatus of example 8, wherein the hash value is a first hash value based on the TLS client sub-profile, and the means for transmitting is to, in response to the first hash value not matching a second hash value of the plurality of the hash values, transmit the first telemetry data and the second telemetry data to the second server, the TLS client sub-profile identified as the unique TLS profile based on the first hash value not matching the second hash value.

Example 11 includes the apparatus of example 8, wherein the hash value is a first hash value based on the TLS client sub-profile, and wherein the second means for generating is to, in response to the first hash value matching a second hash value of the plurality of the hash values, generate a third hash value based on the TLS server sub-profile, the second hash value corresponding to a known TLS client sub-profile, and the means for transmitting is to, in response to the third hash value not matching a fourth hash value of the plurality of the hash values, transmit the first hash value and the second telemetry data to the second server, the fourth hash value corresponding to a known TLS server sub-profile, the TLS server sub-profile identified as the unique TLS profile based on the third hash value not matching the fourth hash value.

Example 12 includes the apparatus of example 8, wherein the TLS server sub-profile is a first TLS server sub-profile, and the first means for generating is to generate a second TLS server sub-profile based on third telemetry data associated with a third server, the second TLS server sub-profile including the second TLS parameter or a third TLS parameter associated with the third server, the third telemetry data is generated in response to the third server transmitting a data communication to the client device.

Example 13 includes the apparatus of example 12, wherein the hash value is a first hash value, and wherein the second means for generating is to generate a second hash value based on the second TLS server sub-profile, and the means for transmitting is to, in response to the second hash value not matching a third hash value of the plurality of the hash values, transmit the third telemetry data to the second server, the third hash value corresponding to a known TLS server sub-profile.

Example 14 includes the apparatus of example 8, wherein the client device is a first client device with a first type, the TLS client sub-profile is a first TLS client sub-profile, the TLS server sub-profile is a first TLS server sub-profile, and further including means for identifying a second type of a second client device in a network including the first client device, and means for receiving at least one of a second TLS client sub-profile or a second TLS server sub-profile from the second server, the second TLS client sub-profile and the second TLS server sub-profile corresponding to the second type.

Example 15 includes At least one non-transitory computer readable medium comprising instructions that, when executed, cause at least one processor to at least generate a Transport Layer Security (TLS) client sub-profile based on first telemetry data associated with a client device, the TLS client sub-profile including a first TLS parameter associated with the client device, generate a TLS server sub-profile based on second telemetry data associated with a first server, the TLS server sub-profile including a second TLS parameter associated with the first server, generate a hash value based on at least one of the TLS client sub-profile or the TLS server sub-profile, compare the hash value to a plurality of hash values corresponding to known hash values, and in response to identifying the at least one of the TLS client sub-profile or the TLS server sub-profile as a unique TLS profile based on the comparisons, transmit the at least one of the first telemetry data or the second telemetry data to a second server.

Example 16 includes the at least one non-transitory computer readable medium of example 15, wherein the first telemetry data is generated in response to the client device transmitting a first data communication to the first server, and the second telemetry data is generated in response to the first server transmitting a second data communication to the client device.

Example 17 includes the at least one non-transitory computer readable medium of example 15, wherein the hash value is a first hash value based on the TLS client sub-profile, and the instructions, when executed, cause the at least one processor to, in response to the first hash value not matching a second hash value of the plurality of the hash values, transmit the first telemetry data and the second telemetry data to the second server, the TLS client sub-profile identified as the unique TLS profile based on the first hash value not matching the second hash value.

Example 18 includes the at least one non-transitory computer readable medium of example 15, wherein the hash value is a first hash value based on the TLS client sub-profile, and the instructions, when executed, cause the at least one processor to in response to the first hash value matching a second hash value of the plurality of the hash values, generate a third hash value based on the TLS server sub-profile, the second hash value corresponding to a known TLS client sub-profile, and in response to the third hash value not matching a fourth hash value of the plurality of the hash values, transmit the first hash value and the second telemetry data to the second server, the fourth hash value corresponding to a known TLS server sub-profile, the TLS server sub-profile identified as the unique TLS profile based on the third hash value not matching the fourth hash value.

Example 19 includes the at least one non-transitory computer readable medium of example 15, wherein the TLS server sub-profile is a first TLS server sub-profile, and the instructions, when executed, cause the at least one processor to generate a second TLS server sub-profile based on third telemetry data associated with a third server, the second TLS server sub-profile including the second TLS parameter or a third TLS parameter associated with the third server, the third telemetry data is generated in response to the third server transmitting a data communication to the client device.

Example 20 includes the at least one non-transitory computer readable medium of example 19, wherein the hash value is a first hash value, and the instructions, when executed, cause the at least one processor to generate a second hash value based on the second TLS server sub-profile, and in response to the second hash value not matching a third hash value of the plurality of the hash values, transmit the third telemetry data to the second server, the third hash value corresponding to a known TLS server sub-profile.

Example 21 includes the at least one non-transitory computer readable medium of example 15, wherein the client device is a first client device with a first type, the TLS client sub-profile is a first TLS client sub-profile, the TLS server sub-profile is a first TLS server sub-profile, and the instructions, when executed, cause the at least one processor to identify a second type of a second client device in a network including the first client device, and receive at least one of a second TLS client sub-profile or a second TLS server sub-profile from the second server, the second TLS client sub-profile and the second TLS server sub-profile corresponding to the second type.

Example 22 includes an apparatus comprising a Transport Layer Security (TLS) profile generator to generate a Transport Layer Security (TLS) client sub-profile based on first telemetry data associated with a client device, the TLS client sub-profile including a first TLS parameter associated with the client device, and generate a TLS server sub-profile based on second telemetry data associated with a first server, the TLS server sub-profile including a second TLS parameter associated with the first server, a hash generator to generate a hash value based on at least one of the TLS client sub-profile or the TLS server sub-profile, a TLS profile comparator to compare the hash value to a plurality of hash values corresponding to known TLS profiles, and a communication interface to transmit the at least one of the first telemetry data or the second telemetry data to a second server in response to identifying the at least one of the TLS client sub-profile or the TLS server sub-profile as a unique TLS profile based on the comparisons.

Example 23 includes the apparatus of example 22, wherein the first telemetry data is generated in response to the client device transmitting a first data communication to the first server, and the second telemetry data is generated in response to the first server transmitting a second data communication to the client device.

Example 24 includes the apparatus of example 22, wherein the hash value is a first hash value based on the TLS client sub-profile, and the communication interface is to, in response to the first hash value not matching a second hash value of the plurality of the hash values, transmit the first telemetry data and the second telemetry data to the second server, the TLS client sub-profile identified as the unique TLS profile based on the first hash value not matching the second hash value.

Example 25 includes the apparatus of example 22, wherein the hash value is a first hash value based on the TLS client sub-profile, and wherein the hash generator is to, in response to the first hash value matching a second hash value of the plurality of the hash values, generate a third hash value based on the TLS server sub-profile, the second hash value corresponding to a known TLS client sub-profile, and the communication interface is to, in response to the third hash value not matching a fourth hash value of the plurality of the hash values, transmit the first hash value and the second telemetry data to the second server, the fourth hash value corresponding to a known TLS server sub-profile, the TLS server sub-profile identified as the unique TLS profile based on the third hash value not matching the fourth hash value.

Example 26 includes the apparatus of example 22, wherein the TLS server sub-profile is a first TLS server sub-profile, and the TLS profile generator is to generate a second TLS server sub-profile based on third telemetry data associated with a third server, the second TLS server sub-profile including the second TLS parameter or a third TLS parameter associated with the third server, the third telemetry data is generated in response to the third server transmitting a data communication to the client device.

Example 27 includes the apparatus of example 26, wherein the hash value is a first hash value, and wherein the hash generator is to generate a second hash value based on the second TLS server sub-profile, and the communication interface is to, in response to the second hash value not matching a third hash value of the plurality of the hash values, transmit the third telemetry data to the second server, the third hash value corresponding to a known TLS server sub-profile.

Example 28 includes the apparatus of example 22, wherein the client device is a first client device with a first type, the TLS client sub-profile is a first TLS client sub-profile, the TLS server sub-profile is a first TLS server sub-profile, and further including a device identifier to identify a second type of a second client device in a network including the first client device, and a communication interface to receive at least one of a second TLS client sub-profile or a second TLS server sub-profile from the second server, the second TLS client sub-profile and the second TLS server sub-profile corresponding to the second type.

Example 29 includes a method comprising generating a Transport Layer Security (TLS) client sub-profile based on first telemetry data associated with a client device, the TLS client sub-profile including a first TLS parameter associated with the client device, generating a TLS server sub-profile based on second telemetry data associated with a first server, the TLS server sub-profile including a second TLS parameter associated with the first server, generating a hash value based on at least one of the TLS client sub-profile or the TLS server sub-profile, comparing the hash value to a plurality of hash values corresponding to known TLS profiles, and in response to identifying the at least one of the TLS client sub-profile or the TLS server sub-profile as a unique TLS profile based on the comparisons, transmitting the at least one of the first telemetry data or the second telemetry data to a second server.

Example 30 includes the method of example 29, wherein the first telemetry data is generated in response to the client device transmitting a first data communication to the first server, and the second telemetry data is generated in response to the first server transmitting a second data communication to the client device.

Example 31 includes the method of example 29, wherein the hash value is a first hash value based on the TLS client sub-profile, and further including, in response to the first hash value not matching a second hash value of the plurality of the hash values, transmitting the first telemetry data and the second telemetry data to the second server, the TLS client sub-profile identified as the unique TLS profile based on the first hash value not matching the second hash value.

Example 32 includes the method of example 29, wherein the hash value is a first hash value based on the TLS client sub-profile, and further including in response to the first hash value matching a second hash value of the plurality of the hash values, generating a third hash value based on the TLS server sub-profile, the second hash value corresponding to a known TLS client sub-profile, and in response to the third hash value not matching a fourth hash value of the plurality of the hash values, transmitting the first hash value and the second telemetry data to the second server, the fourth hash value corresponding to a known TLS server sub-profile, the TLS server sub-profile identified as the unique TLS profile based on the third hash value not matching the fourth hash value.

Example 33 includes the method of example 29, wherein the TLS server sub-profile is a first TLS server sub-profile, and further including generating a second TLS server sub-profile based on third telemetry data associated with a third server, the second TLS server sub-profile including the second TLS parameter or a third TLS parameter associated with the third server, the third telemetry data is generated in response to the third server transmitting a data communication to the client device.

Example 34 includes the method of example 33, wherein the hash value is a first hash value, and further including generating a second hash value based on the second TLS server sub-profile, and in response to the second hash value not matching a third hash value of the plurality of the hash values, transmitting the third telemetry data to the second server, the third hash value corresponding to a known TLS server sub-profile.

Example 35 includes the method of example 29, wherein the client device is a first client device with a first type, the TLS client sub-profile is a first TLS client sub-profile, the TLS server sub-profile is a first TLS server sub-profile, and further including identifying a second type of a second client device in a network including the first client device, and receiving at least one of a second TLS client sub-profile or a second TLS server sub-profile from the second server, the second TLS client sub-profile and the second TLS server sub-profile corresponding to the second type.

Example 36 includes an apparatus comprising at least one memory, instructions, and at least one processor to execute the instructions to generate a Transport Layer Security (TLS) profile based on telemetry data obtained from a network device, the telemetry data associated with at least one of a client device in communication with a network device or a server in communication with the network device, the TLS profile including a TLS parameter of a TLS message, generate a hash value based on the TLS profile, compare the hash value to a plurality of hash values corresponding to known TLS profiles, and identify the TLS profile as a unique TLS profile based on the comparisons.

Example 37 includes the apparatus of example 36, wherein the telemetry data is based on the TLS message transmitted from the client device to the server, the TLS profile is a TLS client sub-profile, the hash value is a first hash value based on the TLS client sub-profile, and the at least one processor is to in response to the first hash value not matching a second hash value of the plurality of the hash values, identify the TLS client sub-profile as the unique TLS profile, and store the first hash value.

Example 38 includes the apparatus of example 36, wherein the TLS message is a first TLS message, the telemetry data is first telemetry data based on the first TLS message transmitted from the client device to the server, the TLS profile is a TLS client sub-profile, the TLS parameter is a first TLS parameter, the hash value is a first hash value based on the TLS client sub-profile, and the at least one processor is to in response to the first hash value matching a second hash value of the plurality of the hash values, generate a TLS server sub-profile based on second telemetry data obtained from the network device, the second hash value corresponding to a known TLS client sub-profile, the second telemetry data based on a second TLS message transmitted from the server to the client device, the second TLS message including a second TLS parameter, generate a third hash value based on the TLS server sub-profile, and in response to the third hash value not matching a fourth hash value of the plurality of the hash values, the fourth hash value corresponding to a known TLS server sub-profile identify the TLS server sub-profile as the unique TLS profile, store an association of the second hash value and the third hash value, and discard the first hash value and the first telemetry data.

Example 39 includes the apparatus of example 36, wherein the TLS profile is a TLS client sub-profile, the hash value is a first hash value based on the TLS client sub-profile, and the at least one processor is to generate a second hash value based on a TLS server sub-profile, execute anomaly detection on the TLS client sub-profile and the TLS server sub-profile, in response to identifying the TLS client sub-profile as associated with a malware attack, label the first hash value as malicious, and in response to identifying the TLS server sub-profile as associated with the malware attack, label the second hash value as malicious.

Example 40 includes the apparatus of example 39, wherein the at least one processor is to in response to identifying the TLS client sub-profile as associated with legitimate network behavior, label the first hash value as legitimate, in response to identifying the TLS server sub-profile as associated with the legitimate network behavior, label the second hash value as legitimate, and generate one or more firewall rules based on at least one of the labeling of the first hash value or the second hash value.

Example 41 includes the apparatus of example 36, the at least one processor is to execute anomaly detection on the TLS profile, in response to identifying the TLS profile as associated with a malware attack, label the hash value as malicious, train a machine-learning model based on the labeling of the hash value as malicious, and distribute the machine-learning model to a plurality of network devices including the network device.

Example 42 includes the apparatus of example 36, wherein the at least one processor is to identify a type of the client device based on the telemetry data, identify at least one of a firewall rule or a machine-learning model based on the type of the client device, and distribute the at least one of the firewall rule or the machine-learning model to the network device, the network device to execute a network security task based on the at least one of the firewall rule or the machine-learning model.

Example 43 includes an apparatus comprising first means for generating a Transport Layer Security (TLS) profile based on telemetry data obtained from a network device, the telemetry data associated with at least one of a client device in communication with a network device or a server in communication with the network device, the TLS profile including a TLS parameter of a TLS message, second means for generating a hash value based on the TLS profile, and means for identifying the TLS profile as a unique TLS profile based on comparisons of the hash value to a plurality of hash values corresponding to known TLS profiles.

Example 44 includes the apparatus of example 43, wherein the telemetry data is based on the TLS message transmitted from the client device to the server, the TLS profile is a TLS client sub-profile, the hash value is a first hash value based on the TLS client sub-profile, and the means for identifying is to in response to the first hash value not matching a second hash value of the plurality of the hash values, identify the TLS client sub-profile as the unique TLS profile, and store the first hash value.

Example 45 includes the apparatus of example 43, wherein the TLS message is a first TLS message, the telemetry data is first telemetry data based on the first TLS message transmitted from the client device to the server, the TLS profile is a TLS client sub-profile, the TLS parameter is a first TLS parameter, the hash value is a first hash value based on the TLS client sub-profile, and wherein the first means for generating is to, in response to the first hash value matching a second hash value of the plurality of the hash values, generate a TLS server sub-profile based on second telemetry data obtained from the network device, the second hash value corresponding to a known TLS client sub-profile, the second telemetry data based on a second TLS message transmitted from the server to the client device, the second TLS message including a second TLS parameter, the second means for generating is to generate a third hash value based on the TLS server sub-profile, and the means for identifying is to, in response to the third hash value not matching a fourth hash value of the plurality of the hash values, the fourth hash value corresponding to a known TLS server sub-profile identify the TLS server sub-profile as the unique TLS profile, store an association of the second hash value and the third hash value, and discard the first hash value and the first telemetry data.

Example 46 includes the apparatus of example 43, wherein the TLS profile is a TLS client sub-profile, the hash value is a first hash value based on the TLS client sub-profile, the second means for generating is to generate a second hash value based on a TLS server sub-profile, and further including means for executing, the means for executing to execute anomaly detection on the TLS client sub-profile and the TLS server sub-profile, in response to identifying the TLS client sub-profile as associated with a malware attack, label the first hash value as malicious, and in response to identifying the TLS server sub-profile as associated with the malware attack, label the second hash value as malicious.

Example 47 includes the apparatus of example 46, wherein the means for executing is to in response to identifying the TLS client sub-profile as associated with legitimate network behavior, label the first hash value as legitimate, in response to identifying the TLS server sub-profile as associated with the legitimate network behavior, label the second hash value as legitimate, and generate one or more firewall rules based on at least one of the labeling of the first hash value or the second hash value.

Example 48 includes the apparatus of example 43, further including means for executing to execute anomaly detection on the TLS profile, in response to identifying the TLS profile as associated with a malware attack, label the hash value as malicious, and train a machine-learning model based on the labeling of the hash value as malicious, and means for distributing to distribute the machine-learning model to a plurality of network devices including the network device.

Example 49 includes the apparatus of example 43, further including means for distributing to identify a type of the client device based on the telemetry data, identify at least one of a firewall rule or a machine-learning model based on the type of the client device, and distribute the at least one of the firewall rule or the machine-learning model to the network device, the network device to execute a network security task based on the at least one of the firewall rule or the machine-learning model.

Example 50 includes At least one non-transitory computer readable medium comprising instructions that, when executed, cause at least one processor to at least generate a Transport Layer Security (TLS) profile based on telemetry data obtained from a network device, the telemetry data associated with at least one of a client device in communication with a network device or a server in communication with the network device, the TLS profile including a TLS parameter of a TLS message, generate a hash value based on the TLS profile, compare the hash value to a plurality of hash values corresponding to known TLS profiles, and identify the TLS profile as a unique TLS profile based on the comparisons.

Example 51 includes the at least one non-transitory computer readable medium of example 50, wherein the telemetry data is based on the TLS message transmitted from the client device to the server, the TLS profile is a TLS client sub-profile, the hash value is a first hash value based on the TLS client sub-profile, and the instructions, when executed, cause the at least one processor to in response to the first hash value not matching a second hash value of the plurality of the hash values, identify the TLS client sub-profile as the unique TLS profile, and store the first hash value.

Example 52 includes the at least one non-transitory computer readable medium of example 50, wherein the TLS message is a first TLS message, the telemetry data is first telemetry data based on the first TLS message transmitted from the client device to the server, the TLS profile is a TLS client sub-profile, the TLS parameter is a first TLS parameter, the hash value is a first hash value based on the TLS client sub-profile, and the instructions, when executed, cause the at least one processor to in response to the first hash value matching a second hash value of the plurality of the hash values, generate a TLS server sub-profile based on second telemetry data obtained from the network device, the second hash value corresponding to a known TLS client sub-profile, the second telemetry data based on a second TLS message transmitted from the server to the client device, the second TLS message including a second TLS parameter, generate a third hash value based on the TLS server sub-profile, and in response to the third hash value not matching a fourth hash value of the plurality of the hash values, the fourth hash value corresponding to a known TLS server sub-profile identify the TLS server sub-profile as the unique TLS profile, store an association of the second hash value and the third hash value, and discard the first hash value and the first telemetry data.

Example 53 includes the at least one non-transitory computer readable medium of example 50, wherein the TLS profile is a TLS client sub-profile, the hash value is a first hash value based on the TLS client sub-profile, and the instructions, when executed, cause the at least one processor to generate a second hash value based on a TLS server sub-profile, execute anomaly detection on the TLS client sub-profile and the TLS server sub-profile, in response to identifying the TLS client sub-profile as associated with a malware attack, label the first hash value as malicious, and in response to identifying the TLS server sub-profile as associated with the malware attack, label the second hash value as malicious.

Example 54 includes the at least one non-transitory computer readable medium of example 53, wherein the instructions, when executed, cause the at least one processor to in response to identifying the TLS client sub-profile as associated with legitimate network behavior, label the first hash value as legitimate, in response to identifying the TLS server sub-profile as associated with the legitimate network behavior, label the second hash value as legitimate, and generate one or more firewall rules based on at least one of the labeling of the first hash value or the second hash value.

Example 55 includes the at least one non-transitory computer readable medium of example 50, wherein the instructions, when executed, cause the at least one processor to execute anomaly detection on the TLS profile, in response to identifying the TLS profile as associated with a malware attack, label the hash value as malicious, train a machine-learning model based on the labeling of the hash value as malicious, and distribute the machine-learning model to a plurality of network devices including the network device.

Example 56 includes the at least one non-transitory computer readable medium of example 50, wherein the instructions, when executed, cause the at least one processor to identify a type of the client device based on the telemetry data, identify at least one of a firewall rule or a machine-learning model based on the type of the client device, and distribute the at least one of the firewall rule or the machine-learning model to the network device, the network device to execute a network security task based on the at least one of the firewall rule or the machine-learning model.

Example 57 includes an apparatus comprising a Transport Layer Security (TLS) profile generator to generate a Transport Layer Security (TLS) profile based on telemetry data obtained from a network device, the telemetry data associated with at least one of a client device in communication with a network device or a server in communication with the network device, the TLS profile including a TLS parameter of a TLS message, a hash generator to generate a hash value based on the TLS profile, and a TLS profile comparator to identify the TLS profile as a unique TLS profile based on comparisons of the hash value to a plurality of hash values corresponding to known TLS profiles.

Example 58 includes the apparatus of example 57, wherein the telemetry data is based on the TLS message transmitted from the client device to the server, the TLS profile is a TLS client sub-profile, the hash value is a first hash value based on the TLS client sub-profile, and the TLS profile comparator is to in response to the first hash value not matching a second hash value of the plurality of the hash values, identify the TLS client sub-profile as the unique TLS profile, and store the first hash value.

Example 59 includes the apparatus of example 57, wherein the TLS message is a first TLS message, the telemetry data is first telemetry data based on the first TLS message transmitted from the client device to the server, the TLS profile is a TLS client sub-profile, the TLS parameter is a first TLS parameter, the hash value is a first hash value based on the TLS client sub-profile, and wherein the TLS profile generator is to, in response to the first hash value matching a second hash value of the plurality of the hash values, generate a TLS server sub-profile based on second telemetry data obtained from the network device, the second hash value corresponding to a known TLS client sub-profile, the second telemetry data based on a second TLS message transmitted from the server to the client device, the second TLS message including a second TLS parameter, the hash generator is to generate a third hash value based on the TLS server sub-profile, and the TLS profile comparator is to, in response to the third hash value not matching a fourth hash value of the plurality of the hash values, the fourth hash value corresponding to a known TLS server sub-profile identify the TLS server sub-profile as the unique TLS profile, store an association of the second hash value and the third hash value, and discard the first hash value and the first telemetry data.

Example 60 includes the apparatus of example 57, wherein the TLS profile is a TLS client sub-profile, the hash value is a first hash value based on the TLS client sub-profile, the hash generator is to generate a second hash value based on a TLS server sub-profile, and further including a security controller, the security controller to execute anomaly detection on the TLS client sub-profile and the TLS server sub-profile, in response to identifying the TLS client sub-profile as associated with a malware attack, label the first hash value as malicious, and in response to identifying the TLS server sub-profile as associated with the malware attack, label the second hash value as malicious.

Example 61 includes the apparatus of example 60, wherein the security controller is to in response to identifying the TLS client sub-profile as associated with legitimate network behavior, label the first hash value as legitimate, in response to identifying the TLS server sub-profile as associated with the legitimate network behavior, label the second hash value as legitimate, and generate one or more firewall rules based on at least one of the labeling of the first hash value or the second hash value.

Example 62 includes the apparatus of example 57, further including a security controller to execute anomaly detection on the TLS profile, in response to identifying the TLS profile as associated with a malware attack, label the hash value as malicious, and train a machine-learning model based on the labeling of the hash value as malicious, and an application distributor to distribute the machine-learning model to a plurality of network devices including the network device.

Example 63 includes the apparatus of example 57, further including an application distributor to identify a type of the client device based on the telemetry data, identify at least one of a firewall rule or a machine-learning model based on the type of the client device, and distribute the at least one of the firewall rule or the machine-learning model to the network device, the network device to execute a network security task based on the at least one of the firewall rule or the machine-learning model.

Example 64 includes a method comprising generating a Transport Layer Security (TLS) profile based on telemetry data obtained from a network device, the telemetry data associated with at least one of a client device in communication with a network device or a server in communication with the network device, the TLS profile including a TLS parameter of a TLS message, generating a hash value based on the TLS profile, comparing the hash value to a plurality of hash values corresponding to known TLS profiles, and identifying the TLS profile as a unique TLS profile based on the comparisons.

Example 65 includes the method of example 64, wherein the telemetry data is based on the TLS message transmitted from the client device to the server, the TLS profile is a TLS client sub-profile, the hash value is a first hash value based on the TLS client sub-profile, and further including in response to the first hash value not matching a second hash value of the plurality of the hash values, identifying the TLS client sub-profile as the unique TLS profile, and storing the first hash value.

Example 66 includes the method of example 64, wherein the TLS message is a first TLS message, the telemetry data is first telemetry data based on the first TLS message transmitted from the client device to the server, the TLS profile is a TLS client sub-profile, the TLS parameter is a first TLS parameter, the hash value is a first hash value based on the TLS client sub-profile, and further including in response to the first hash value matching a second hash value of the plurality of the hash values, generating a TLS server sub-profile based on second telemetry data obtained from the network device, the second hash value corresponding to a known TLS client sub-profile, the second telemetry data based on a second TLS message transmitted from the server to the client device, the second TLS message including a second TLS parameter, generating a third hash value based on the TLS server sub-profile, and in response to the third hash value not matching a fourth hash value of the plurality of the hash values, the fourth hash value corresponding to a known TLS server sub-profile identifying the TLS server sub-profile as the unique TLS profile, storing an association of the second hash value and the third hash value, and discarding the first hash value and the first telemetry data.

Example 67 includes the method of example 64, wherein the TLS profile is a TLS client sub-profile, the hash value is a first hash value based on the TLS client sub-profile, and further including generating a second hash value based on a TLS server sub-profile, executing anomaly detection on the TLS client sub-profile and the TLS server sub-profile, in response to identifying the TLS client sub-profile as associated with a malware attack, labeling the first hash value as malicious, and in response to identifying the TLS server sub-profile as associated with the malware attack, labeling the second hash value as malicious.

Example 68 includes the method of example 67, further including in response to identifying the TLS client sub-profile as associated with legitimate network behavior, labeling the first hash value as legitimate, in response to identifying the TLS server sub-profile as associated with the legitimate network behavior, labeling the second hash value as legitimate, and generating one or more firewall rules based on at least one of the labeling of the first hash value or the second hash value.

Example 69 includes the method of example 64, further including executing anomaly detection on the TLS profile, in response to identifying the TLS profile as associated with a malware attack, labeling the hash value as malicious, training a machine-learning model based on the labeling of the hash value as malicious, and distributing the machine-learning model to a plurality of network devices including the network device.

Example 70 includes the method of example 64, further including identifying a type of the client device based on the telemetry data, identifying at least one of a firewall rule or a machine-learning model based on the type of the client device, and distributing the at least one of the firewall rule or the machine-learning model to the network device, the network device to execute a network security task based on the at least one of the firewall rule or the machine-learning model.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
at least one memory;
instructions; and
at least one processor to execute the instructions to:
generate a Transport Layer Security (TLS) client sub-profile based on first telemetry data associated with a client device, the TLS client sub-profile including a first TLS parameter associated with the client device;
generate a TLS server sub-profile based on second telemetry data associated with a first server, the TLS server sub-profile including a second TLS parameter associated with the first server;
generate a hash value based on at least one of the TLS client sub-profile or the TLS server sub-profile;
compare the hash value to a plurality of hash values corresponding to known TLS profiles; and
in response to identifying the at least one of the TLS client sub-profile or the TLS server sub-profile as a unique TLS profile based on the comparisons, transmit the at least one of the first telemetry data or the second telemetry data to a second server.

2. The apparatus of claim 1, wherein the first telemetry data is generated in response to the client device transmitting a first data communication to the first server, and the second telemetry data is generated in response to the first server transmitting a second data communication to the client device.

3. The apparatus of claim 1, wherein the hash value is a first hash value based on the TLS client sub-profile, and the at least one processor is to, in response to the first hash value not matching a second hash value of the plurality of the hash values, transmit the first telemetry data and the second telemetry data to the second server, the TLS client sub-profile identified as the unique TLS profile based on the first hash value not matching the second hash value.

4. The apparatus of claim 1, wherein the hash value is a first hash value based on the TLS client sub-profile, and the at least one processor is to:
in response to the first hash value matching a second hash value of the plurality of the hash values, generate a third hash value based on the TLS server sub-profile, the second hash value corresponding to a known TLS client sub-profile; and
in response to the third hash value not matching a fourth hash value of the plurality of the hash values, transmit the first hash value and the second telemetry data to the second server, the TLS server sub-profile identified as the unique TLS profile based on the third hash value not matching the fourth hash value, the fourth hash value corresponding to a known TLS server sub-profile.

5. The apparatus of claim 1, wherein the TLS server sub-profile is a first TLS server sub-profile, and the at least one processor is to generate a second TLS server sub-profile based on third telemetry data associated with a third server, the second TLS server sub-profile including the second TLS parameter or a third TLS parameter associated with the third server, the third telemetry data is generated in response to the third server transmitting a data communication to the client device.

6. The apparatus of claim 5, wherein the hash value is a first hash value, and the at least one processor is to:
generate a second hash value based on the second TLS server sub-profile; and
in response to the second hash value not matching a third hash value of the plurality of the hash values, transmit the third telemetry data to the second server, the third hash value corresponding to a known TLS server sub-profile.

7. The apparatus of claim 1, wherein the client device is a first client device with a first type, the TLS client sub-profile is a first TLS client sub-profile, the TLS server sub-profile is a first TLS server sub-profile, and the at least one processor is to:
identify a second type of a second client device in a network including the first client device; and
receive at least one of a second TLS client sub-profile or a second TLS server sub-profile from the second server, the second TLS client sub-profile and the second TLS server sub-profile corresponding to the second type.

8. An apparatus comprising:
first means for generating to:
generate a Transport Layer Security (TLS) client sub-profile based on first telemetry data associated with a client device, the TLS client sub-profile including a first TLS parameter associated with the client device; and
generate a TLS server sub-profile based on second telemetry data associated with a first server, the TLS server sub-profile including a second TLS parameter associated with the first server;
second means for generating a hash value based on at least one of the TLS client sub-profile or the TLS server sub-profile;
means for comparing the hash value to a plurality of hash values corresponding to known TLS profiles; and
means for transmitting the at least one of the first telemetry data or the second telemetry data to a second server in response to identifying the at least one of the TLS client sub-profile or the TLS server sub-profile as a unique TLS profile based on the comparisons.

9. The apparatus of claim 8, wherein the first telemetry data is generated in response to the client device transmitting a first data communication to the first server, and the second telemetry data is generated in response to the first server transmitting a second data communication to the client device.

10. The apparatus of claim 8, wherein the hash value is a first hash value based on the TLS client sub-profile, and the means for transmitting is to, in response to the first hash value not matching a second hash value of the plurality of the hash values, transmit the first telemetry data and the second telemetry data to the second server, the TLS client sub-profile identified as the unique TLS profile based on the first hash value not matching the second hash value.

11. The apparatus of claim 8, wherein the hash value is a first hash value based on the TLS client sub-profile, and wherein:
the second means for generating is to, in response to the first hash value matching a second hash value of the plurality of the hash values, generate a third hash value based on the TLS server sub-profile, the second hash value corresponding to a known TLS client sub-profile; and
the means for transmitting is to, in response to the third hash value not matching a fourth hash value of the plurality of the hash values, transmit the first hash value and the second telemetry data to the second server, the fourth hash value corresponding to a known TLS server sub-profile, the TLS server sub-profile identified as the unique TLS profile based on the third hash value not matching the fourth hash value.

12. The apparatus of claim 8, wherein the TLS server sub-profile is a first TLS server sub-profile, and the first means for generating is to generate a second TLS server sub-profile based on third telemetry data associated with a third server, the second TLS server sub-profile including the second TLS parameter or a third TLS parameter associated with the third server, the third telemetry data is generated in response to the third server transmitting a data communication to the client device.

13. The apparatus of claim 12, wherein the hash value is a first hash value, and wherein:
the second means for generating is to generate a second hash value based on the second TLS server sub-profile; and
the means for transmitting is to, in response to the second hash value not matching a third hash value of the plurality of the hash values, transmit the third telemetry data to the second server, the third hash value corresponding to a known TLS server sub-profile.

14. The apparatus of claim 8, wherein the client device is a first client device with a first type, the TLS client sub-profile is a first TLS client sub-profile, the TLS server sub-profile is a first TLS server sub-profile, and further including:
means for identifying a second type of a second client device in a network including the first client device; and
means for receiving at least one of a second TLS client sub-profile or a second TLS server sub-profile from the second server, the second TLS client sub-profile and the second TLS server sub-profile corresponding to the second type.

15. At least one non-transitory computer readable medium comprising instructions that, when executed, cause at least one processor to at least:
generate a Transport Layer Security (TLS) client sub-profile based on first telemetry data associated with a client device, the TLS client sub-profile including a first TLS parameter associated with the client device;
generate a TLS server sub-profile based on second telemetry data associated with a first server, the TLS server sub-profile including a second TLS parameter associated with the first server;
generate a hash value based on at least one of the TLS client sub-profile or the TLS server sub-profile;
compare the hash value to a plurality of hash values corresponding to known hash values; and
in response to identifying the at least one of the TLS client sub-profile or the TLS server sub-profile as a unique TLS profile based on the comparisons, transmit the at least one of the first telemetry data or the second telemetry data to a second server.

16. The at least one non-transitory computer readable medium of claim 15, wherein the first telemetry data is generated in response to the client device transmitting a first data communication to the first server, and the second telemetry data is generated in response to the first server transmitting a second data communication to the client device.

17. The at least one non-transitory computer readable medium of claim 15, wherein the hash value is a first hash value based on the TLS client sub-profile, and the instructions, when executed, cause the at least one processor to, in response to the first hash value not matching a second hash value of the plurality of the hash values, transmit the first telemetry data and the second telemetry data to the second server, the TLS client sub-profile identified as the unique TLS profile based on the first hash value not matching the second hash value.

18. The at least one non-transitory computer readable medium of claim 15, wherein the hash value is a first hash value based on the TLS client sub-profile, and the instructions, when executed, cause the at least one processor to:
in response to the first hash value matching a second hash value of the plurality of the hash values, generate a third hash value based on the TLS server sub-profile, the second hash value corresponding to a known TLS client sub-profile; and
in response to the third hash value not matching a fourth hash value of the plurality of the hash values, transmit the first hash value and the second telemetry data to the second server, the fourth hash value corresponding to a known TLS server sub-profile, the TLS server sub-profile identified as the unique TLS profile based on the third hash value not matching the fourth hash value.

19. The at least one non-transitory computer readable medium of claim 15, wherein the TLS server sub-profile is a first TLS server sub-profile, and the instructions, when executed, cause the at least one processor to generate a second TLS server sub-profile based on third telemetry data associated with a third server, the second TLS server sub-profile including the second TLS parameter or a third TLS parameter associated with the third server, the third telemetry data is generated in response to the third server transmitting a data communication to the client device.

20. The at least one non-transitory computer readable medium of claim 19, wherein the hash value is a first hash value, and the instructions, when executed, cause the at least one processor to:
generate a second hash value based on the second TLS server sub-profile; and
in response to the second hash value not matching a third hash value of the plurality of the hash values, transmit the third telemetry data to the second server, the third hash value corresponding to a known TLS server sub-profile.

21. The at least one non-transitory computer readable medium of claim 15, wherein the client device is a first client device with a first type, the TLS client sub-profile is a first TLS client sub-profile, the TLS server sub-profile is a first TLS server sub-profile, and the instructions, when executed, cause the at least one processor to:
identify a second type of a second client device in a network including the first client device; and
receive at least one of a second TLS client sub-profile or a second TLS server sub-profile from the second server, the second TLS client sub-profile and the second TLS server sub-profile corresponding to the second type.

22. An apparatus comprising:
a Transport Layer Security (TLS) profile generator to:
generate a Transport Layer Security (TLS) client sub-profile based on first telemetry data associated with a client device, the TLS client sub-profile including a first TLS parameter associated with the client device; and
generate a TLS server sub-profile based on second telemetry data associated with a first server, the TLS server sub-profile including a second TLS parameter associated with the first server;
a hash generator to generate a hash value based on at least one of the TLS client sub-profile or the TLS server sub-profile;
a TLS profile comparator to compare the hash value to a plurality of hash values corresponding to known TLS profiles; and
a communication interface to transmit the at least one of the first telemetry data or the second telemetry data to a second server in response to identifying the at least one of the TLS client sub-profile or the TLS server sub-profile as a unique TLS profile based on the comparisons.

23. The apparatus of claim 22, wherein the first telemetry data is generated in response to the client device transmitting a first data communication to the first server, and the second telemetry data is generated in response to the first server transmitting a second data communication to the client device.

24. The apparatus of claim 22, wherein the hash value is a first hash value based on the TLS client sub-profile, and the communication interface is to, in response to the first hash value not matching a second hash value of the plurality of the hash values, transmit the first telemetry data and the second telemetry data to the second server, the TLS client sub-profile identified as the unique TLS profile based on the first hash value not matching the second hash value.

25. The apparatus of claim 22, wherein the hash value is a first hash value based on the TLS client sub-profile, and wherein:
the hash generator is to, in response to the first hash value matching a second hash value of the plurality of the hash values, generate a third hash value based on the TLS server sub-profile, the second hash value corresponding to a known TLS client sub-profile; and
the communication interface is to, in response to the third hash value not matching a fourth hash value of the plurality of the hash values, transmit the first hash value and the second telemetry data to the second server, the fourth hash value corresponding to a known TLS server sub-profile, the TLS server sub-profile identified as the unique TLS profile based on the third hash value not matching the fourth hash value.

26-70. (canceled)
